(19) United States
(12) Patent Application Publication
(10) Pub. No.: US 2006/0229928 A1
(43) Pub. Date: Oct. 12, 2006

(54) System and method of tracking objects being serviced

(76) Inventor: James L. Nix JR., Aliso Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/103,969

(22) Filed: Apr. 12, 2005

(51) Int. Cl. G06Q 99/00; G06F 15/02; G06F 9/46

(52) U.S. Cl. 705/9; 705/1

(57) ABSTRACT

A system of tracking objects through a service process at a service shop comprises a computer network configured to track movement of tagged service objects from physical location to physical location within the service shop. The computer network comprises tag readers with antennae configured to receive transmissions from tags encoded with identifiers and connected to associated tagged service objects. The tag readers transmit identifiers obtained from the tag transmissions together with an indication as to which antenna received each transmission. Servers receive the identifiers transmitted from the tag readers and determine, based at least on the identifiers and which tag reader antenna received the transmissions, which physical location each service object associated with the received identifiers occupies. Client workstations generate a visual map of physical locations together with summary status information showing which service objects occupy the displayed physical locations.

### BACKGROUND

1. Field of the Relevant Art

This disclosure relates to tracking physical locations of objects as the objects are being serviced.

2. Description of the Related Art

Many service shops exist that provide service for objects, such as automobiles, in need of service. Typically, a service shop has a number of physical locations. Particular servicing steps are performed at least some of the physical locations. For example, at an automobile service shop, a paint room provides a physical location for painting automobiles. Generally, when an object is serviced, it moves from physical location to physical location in a service shop as each servicing step is completed.

Service shops typically want to provide service for objects quickly in order to ensure maximum productivity and profit. To achieve this result, service shops attempt to monitor the physical location of each object in the service shop, efficiently schedule each physical location to achieve maximum capacity, and ensure that each object moves as quickly as possible from one physical location to the next. However, systems and methods for tracking the physical location of service objects and assisting with these functions have been inadequate.

### SUMMARY

The embodiments of the systems and methods described herein provide mechanisms for tracking service objects as they move from one physical location to another in a service shop. These systems and methods can improve the productivity of a service shop, ensure that objects are serviced as quickly as possible, and increase service shop profits. This summary provides a convenient and brief summary of certain embodiments of the invention claimed herein. To maintain its convenience and brevity, this summary necessarily sacrifices an ability to describe every embodiment of the invention. The summary does not particularly point out and claim the invention and it does not describe every embodiment of the invention. A person of ordinary skill in the art will appreciate, in light of the entire disclosure, including the claims, that the invention encompasses embodiments that may be either broader than or narrower than the embodiments described in this summary.

Embodiments of a tracking system track service objects as they progress through a service process at a service shop. The term “service object” encompasses any object in need of service including, without limitation, an automobile, a vehicle, a computer, a telephone, a camera, a personal digital assistant, and the like. The term “service” encompasses any service activity that a service object can receive, including, without limitation, repair, maintenance, lubrication, painting, filling with gas, replacing oil, calibration, tuning, recharging, software installation, programming, and the like. The term “service process” encompasses any process comprising one or more steps performed to service a service object. A service process can also be associated with one or more physical locations where the servicing steps are performed.

A service shop can advantageously use embodiments of a service object tracking system in order to increase productivity, schedule physical locations of the service shop to achieve maximum capacity, maintain up-to-date information regarding the physical location of each service object, and increase profits. An example of a service shop that uses such a tracking system comprises an optional tagging area, one or more physical locations, a computer network that detects identifier transmitters or tags and maintains information regarding the physical location occupied by tagged service objects, and an optional office. At the optional tagging area, persons or automated equipment tags service objects that have entered the service shop with object identifier tags that are encoded with unique identifier codes. Preferably, each tag remains connected to its associated service object at least from the time the service object becomes tagged until the time that the service object has completed its service process.

Each tag transmits its encoded identifier continuously, periodically, or when requested by a receiver. The transmission preferably comprises a suitable form of wireless transmission such that receivers or tag readers can read the object identifier information without performing an optical scan of a tag or being in the line-of-sight of the tag. Alternatively to receiving a tag at a tagging area, some service objects may arrive at the service shop pre-tagged. This occurs, for example, for service objects that have been permanently tagged as part of a manufacturing process or during a previous visit to a service shop.

After receiving a tag, a service object proceeds to one or more of the service shop's physical locations. In some embodiments, a computer network can associate a service process with each tagged object that defines the services to be performed on the service object and the physical locations to be visited in order to receive such services. The computer network, which comprises tag readers, one or more servers, and one or more client workstations, detects and keeps track of the physical location of each tagged service object. The tag readers comprise one or more antennae configured to receive transmissions from the tags and to transmit readings to the servers. The servers comprise one or more modules configured to interpret the tag readers' readings and to determine the location that each tagged service object occupies. The client workstations comprise one or more modules configured to display status information or reports regarding the past, present, or expected future location of the tagged service objects. From this information, the system can generate visual maps of all or part of the service shop that advantageously show which tagged service objects occupy the locations displayed on the visual map. Preferably, large screen displays mounted on walls show such visual maps at many places in the service shop.

Embodiments of the tracking system perform advantageous processes for tracking service objects and generating valuable information and reports. One such process comprises: (1) receiving objects to be serviced, (2) associating each object with an object identifier transmitter, (3) receiving signals indicative of object identifiers at receivers located within the service shop, (4) determining which objects are at each location based on the received signals, (5) displaying a map depicting at least some locations and objects located at the depicted locations, (6) receiving a user selection of a depicted object, and (7) displaying status information about the selected object. Another such process comprises: (1) receiving objects to be serviced, (2) associating each object with an object identifier transmitter, (3) defining a service process for each object, (4) receiving signals indicative of object identifiers at receivers located at locations within the service shop, (5) determining which objects are at each location based on the received signals, and (6) calculating an estimated time for a given object to complete its service process based on current locations and defined service processes of the objects.

The application describes these and other embodiments with reference to the drawings listed below.

### BRIEF DESCRIPTION OF THE DRAWINGS

FIG. 1A is a block diagram of a service shop that uses an embodiment of a service object tracking system.

FIG. 1B is a flowchart that illustrates a service process.

FIG. 2 is a block diagram that illustrates an embodiment of a shop map display.

FIGS. 3A and 3B are simplified screen shots that illustrate an embodiment of reporting features enabled by the tracking system of FIG. 1A.

FIGS. 4A and 4B are simplified screen shots that illustrate an embodiment of a customer service status web access module.

FIG. 5 illustrates one embodiment of a network architecture for implementing a service object tracking system.

FIG. 6A is a simplified screen shot that illustrates a service path listing showing the path that a particular service object has taken through a service shop.

FIG. 6B is a simplified screen shot that illustrates information regarding any delays that have occurred in the process of servicing a service object.

FIG. 6C is a simplified screen shot that illustrates a forecast of a service object's service path, including physical locations that the service object has visited, the current physical location of the service object, and physical locations that the service object is projected to visit, together with expected arrival and departure times for each physical location.

FIG. 7 is a simplified screen shot that illustrates a delay notification that provides a dialog box to allow a user to enter a reason for the delay in the servicing of a service object.

FIG. 8 is a simplified screen shot that illustrates a user interface for a tag writer interface.

FIG. 9 is a block diagram that illustrates an embodiment of a server and types of data stored on the server.

FIG. 10 is a simplified screen shot that illustrates a user interface for a data transfer station for receiving readings from tag readers.

FIG. 11 illustrates detection and triangulation of a tag detected by multiple tag readers.

FIG. 12 is a flowchart illustrating a process of tracking objects being serviced.

FIG. 13 is a flowchart illustrating another process of tracking objects being serviced.

### DETAILED DESCRIPTION OF PREFERRED AND ALTERNATIVE EMBODIMENTS

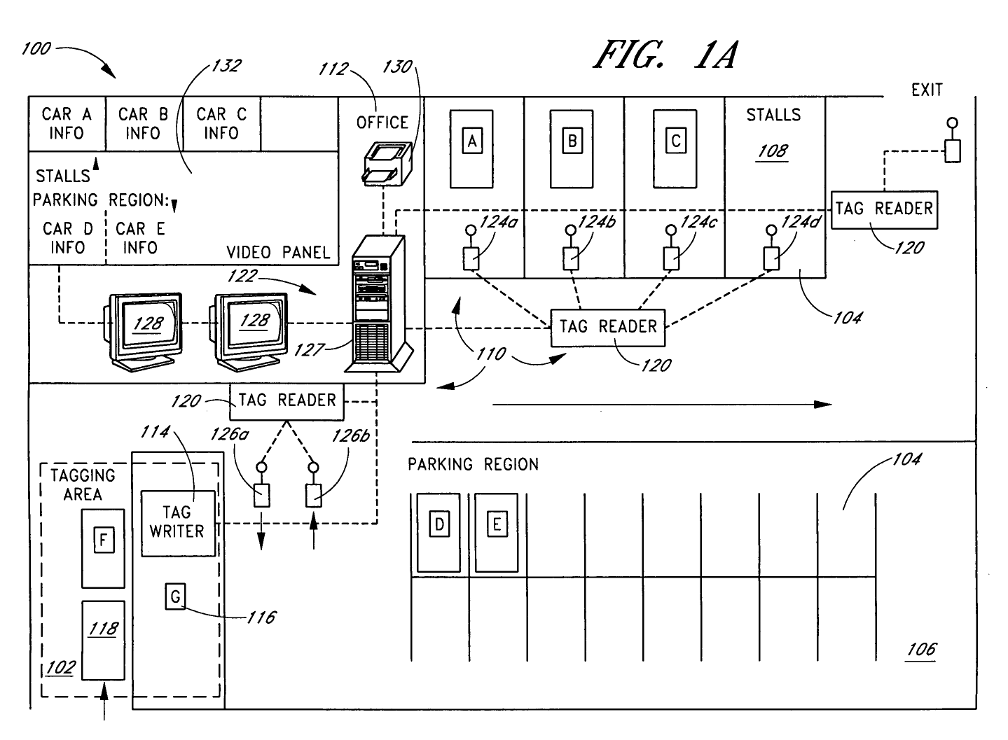

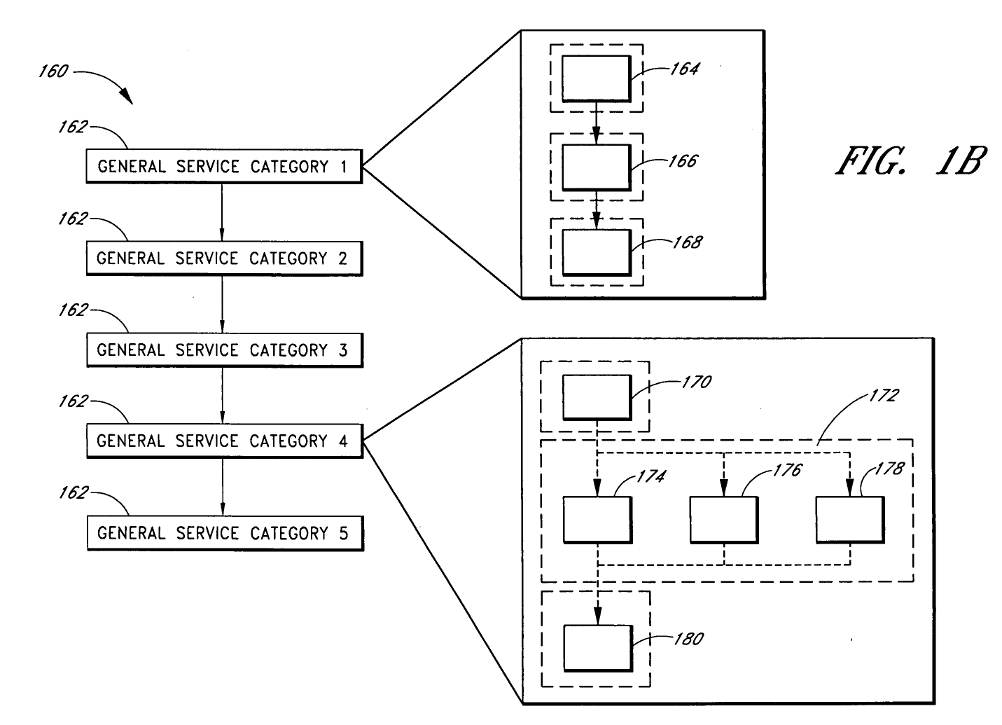

FIG. 1A is a block diagram of a service shop that uses an embodiment of a service object tracking system. Generally, a tracking system as described herein tracks service objects as they progress through a service process at a service shop. This application primarily describes a system that tracks automobiles as they progress through a service process at a service shop. An automobile is one kind of service object. A skilled artisan will appreciate, however, in light of this disclosure, that the systems and methods described herein can be used to track any service object. Accordingly, any reference in this application to the terms “automobile,” “vehicle,” “car,” or the like will be understood by a skilled artisan to also apply to any generic service object.

A service shop 100 comprises an optional tagging area 102, one or more physical locations 104, a tracking system 110, and an optional office 112. In this application the phrase “physical locations” means “one or more physical locations,” while “plurality of physical locations” means “two or more physical locations.” Similarly, the foregoing construction applies generally throughout this application, such that whenever this application uses the construction “one or more<plural noun>,” subsequent uses of “<plural noun>” mean “one or more <plural noun>,” while “plurality of <plural noun>” means “two or more <plural noun>.”

When an automobile 118 first enters the service shop 100, the automobile 118 is optionally processed at the tagging area 102. At the tagging area 102, a tag writer 114 encodes an automobile identifier or repair order identifier onto an identifier transmitter 116 or tag 116. In this application “automobile identifier or repair order identifier” encompasses any one of the following: (1) an automobile identifier alone, (2) a repair order identifier alone, or (3) an automobile identifier and a repair order identifier. Similarly, this construction applies generally throughout this application, such that <noun A> or <noun B> encompasses any one of (1) <noun A> alone, (2) <noun B> alone, or (3) <noun A> and <noun B>. The encoded tag 116 is permanently or temporarily detached to the automobile 118. In one embodiment in which the tag 116 is attached to a magnetic hat which is magnetically attached to a metal surface on the automobile 118, such as the roof of the automobile 118. The automobile identifier or repair order identifier comprises a code that uniquely identifies the automobile or the repair order within the computer system of the repair shop 100. The code can be any length and can be any combination of numbers, letters, and other symbols. In embodiments illustrated by this application, the code is a four digit number and identifies a repair order, but this is not required. A skilled artisan will appreciate, in light of this disclosure, that there are advantages to having the code identify a purchase order but also advantages to having the code identify an automobile. One advantage of having the code identify an automobile is that the same code can be used whenever a given automobile returns to the service shop 100 for service. On the other hand, having the code identify a repair order rather than an automobile can simplify record keeping, in that any automobile can simply be tagged using the next available repair order number, without looking up previous records to determine whether the automobile has previously visited the repair shop 100 and has already been assigned an identification code. Even when a repair order code is used, it is preferable to also identify the automobile within the computer system of the service shop 100, in order to keep track of an automobile's service history at the service shop 100.

As indicated, the tagging area 102 and the step of tagging each automobile 118 or other service object upon entrance to the service shop 100 are optional. Various alternative embodiments exist in which such tagging need not occur, at least with regard to second and subsequent visits to the service shop 100. In one embodiment, whenever a previously untagged automobile enters the service shop 100, the tag 116 can be attached to the automobile 118 permanently such that the automobile 118 need not be tagged or pass through the tagging area 102 on any subsequent visit to the service shop 100. Alternatively, some objects can advantageously be pre-tagged, such as at the time of their manufacture, such that when such pre-tagged objects require service they will already have an identification tag when they enter a service shop 100. Advantageously, in either of these cases or any other case in which an automobile 118 or other service object has already been tagged, the automobile 118 can be identified by an entrance tag reader upon entering into the service shop 100 and can be automatically entered into the computer network 122 of the service shop 100.

The code encoded on a tag can be a code that has been used in the past for another repair order for the same or a different automobile. Preferably, however, each code currently assigned to a tag and being tracked by the tracking system 110 is distinct from any other code currently in the system. Still more preferably, each automobile or repair order is assigned a distinct code, such that historical information regarding past repairs to the same automobile can be maintained in the system without creating a code that is ambiguous.

The physical locations 104 comprise either (1) one or more physical regions 106 and one or more physical stalls 108, (2) one or more physical regions 106 but no physical stalls 108, or (3) no physical regions 106 but one or more physical stalls 108. A physical region 106 is a physical location configured to store more than one automobile at a time. One example of a physical region, such as illustrated by physical region 106 in FIG. 1, is a parking lot. A physical stall 108 is a physical location configured to store one car at a time. Generally, at least some of the physical locations 104 are configured as stations where certain servicing activities are performed. For example, a physical location can be a paint room, which is configured as a place where painting is performed. Alternatively, a physical location can be configured as a place where a service object can reside but at which no active service activities are performed, such as, for example, a parking lot. Without limitation, a physical location can be a room, a defined area whether located inside or outside a building or other structure, or any other place.

The tracking system 110 comprises one or more tag readers 120 and a computer network 122. Each tag reader 120 has one or more antennae 124a-124d. One preferred embodiment uses the commercially available Texas Instruments Series 2000 Reader with RS422/485 interface for the tag readers 120. These readers connect to a Series 2000 4-Channel Multiplexer, which in turn connects to four Series 2000 tuning modules and antennae. Accordingly, in this embodiment, each tag reader 120 has four antennae 124a-124d. Preferably, each antenna 124a is configured to read any tag that is within a defined geographic area. Preferably, the defined geographic area that each antenna 124a covers corresponds to a specific physical location 104. In one embodiment, each antenna 124a reads any tag that is within reception range of the antenna 124a. For example, the antennae of the Texas Instruments Series 2000 reader have a range defined by a circle with a diameter of between approximately 4 and 6 feet. A skilled artisan will appreciate, in light of this disclosure, that while the geographic area covered by each antenna 124a corresponds to a physical location 104, the covered geographic area and the corresponding physical location 104 may have different shapes, and the antenna 124a may not cover every portion of the corresponding physical location 104. For example, a rectangular physical stall 108 may correspond to an antenna 124a that covers a circular geographic area that encompasses much of but not all of the physical stall 108. Preferably, each antenna 124a is configured to cover as much of the geographic area encompassed by a corresponding physical location 104 as possible. Furthermore, each antenna 124a preferably covers a portion of the corresponding physical location 104 that has a high probability of containing the tag 116 of an automobile 118 when the automobile 118 is located at the physical location 104.

Alternative ways exist for detecting each tag's physical location. This application describes some of these alternatives below in the section entitled “Data Transfer Station.” A skilled artisan will appreciate other alternatives in light of this disclosure.

As described in the preceding paragraphs, each antenna 124a of each tag reader 120 detects any tags that are physically located within the reception range of the antenna 124a. Automobiles 118 and other service objects tend to occupy a physical stall 108 for a period of time, such as while the automobile 118 is being painted in a physical stall 108 set aside for painting. Furthermore, an antenna 124a can feasibly receive transmissions for any tag within a single physical stall 108 because physical stalls 108 hold one automobile 118 at a time. In accordance with the foregoing characteristics of service objects and physical stalls 108, it is generally preferable to associate antennae 124a-124d with each physical stall 108 in order to precisely identify which automobile 118 occupies each physical stall 108.

Physical regions 106, on the other hand, can contain multiple automobiles 118. For example, the illustrated physical region 106, a parking lot, can hold 16 automobiles. Many parking lots can hold many more than 16 automobiles. Accordingly, with regard to physical regions 106, cost considerations may render infeasible the precise tracking of each automobile within the physical region. For example, with regard to a parking lot, determining which automobile occupies a particular parking slot may not be feasible. While such precise tracking could be accomplished by, for example, providing an antenna 124a corresponding to each parking slot, advantageous embodiments provide a way to determine which automobiles 118 occupy a generalized physical region 106 without precisely identifying the specific physical space within the physical region 106 occupied by each automobile 118. In one such embodiment, each physical region 106 has an entrance antenna 126a for detecting when an automobile 118 enters the physical region 106 and an exit antenna 126b for detecting when the automobile 118 exits the physical region 106. The computer network 122 keeps track of the automobiles 118 that are in each physical region 106. All automobiles 118 that have been detected by the entrance antenna 126a but have not been detected by the exit antenna 126b are deemed to be within the physical region 106.

Alternatively, one or more combination entrance/exit antennae can be used to determine which automobiles 118 are in a particular physical region 106. In this embodiment, an entrance/exit antenna is placed in the area of each entrance and exit to the physical region 106. Whenever an automobile 118 which is not currently deemed to be in the physical region 106 passes through the geographic area scanned by an entrance/exit antenna, the computer network 122 assumes that the automobile 118 has entered the physical region 106 and assigns the automobile 118 to the physical region 106. Similarly, when an automobile 118 that is currently deemed to be in the physical region 106 passes through the geographic area scanned by an entrance/exit antenna, the computer network 122 assumes that the automobile 118 has exited the physical region 106 and revokes the previous assignment to the physical region 106.

The computer network 122 comprises one or more servers 127, one or more workstations 128, one or more printers 130, and one or more display screens 132. A skilled artisan will appreciate in light of this disclosure that a server can be configured to perform the functions of a workstation and that a workstation can be configured to perform the functions of a server. Accordingly, while this application describes particular functions as being performed on the servers and describes other functions as being performed on the workstations, a skilled artisan will appreciate, in light of this disclosure, that any of the functions can be performed on servers, on workstations, or can be distributed such that it is performed on any combination of servers and workstations, including a single computer that functions as both a server and a workstation. Any of the foregoing embodiments and any alternative embodiment known to a skilled artisan in light of this disclosure are within the scope of this disclosure.

The servers 127 receive information about the readings performed by each tag reader 120 and maintain information in at least one database regarding those readings. In one embodiment, the servers 127 maintain sufficient information about such readings to track the physical location occupied by each automobile 118 that has a tag 116 and that has entered a service shop 100. For example, in one embodiment this information includes, for each automobile 118, a current physical location, a length of time that the automobile 118 has been at the current physical location, and a service path history of the automobile 118 that includes the physical locations that the automobile 118 has visited along with the length of time spent at each previous physical location. For automobiles 118 that have been associated with a service process, the information may also include a service path that includes, in addition to the service path history, a sequence of physical locations 104 that the automobile 118 is scheduled to visit but has not yet visited. The workstations 128 are configured to display reports and other information about the automobiles 118 that are being serviced or have been serviced at the service shop 100. Such reports and information can be printed to the printers 130. The display screens 132 connect to at least one of the workstations 128 and displays whichever report is displayed on the particular workstation 128. Advantageously, one such report that can be displayed on the display screens 132 is a graphical map of the service shop that depicts at least some of the physical locations 104 of the repair shop 100 along with information regarding which automobiles 118 currently occupy the depicted physical locations 104.

The office 112 comprises physical space for housing the computer network 122 including the servers 127, the workstations 128, the printers 130, and the display screens 132. The office 112 can be but need not be a single room in the service shop 100. The office 112 may be distributed throughout the service shop 112. For example, in some embodiments, at least some of the workstations 128, the printers 130, or the display screens 132 are housed within or accessible to the physical locations 104 of the service shop 100. Advantageously, this arrangement allows, for example, a worker working in one particular physical stall 108 of the service shop 100 to view the map showing which automobiles 118 currently occupy the depicted physical locations 104, without leaving the particular physical stall 108 in which the worker is working. Preferably, the servers 127 or any other computer with sensitive data, is located in a secure area apart from the physical locations 104 in which servicing is occurring, in order to minimize any danger of losing data. This, however, is not required.

Shop Map Display

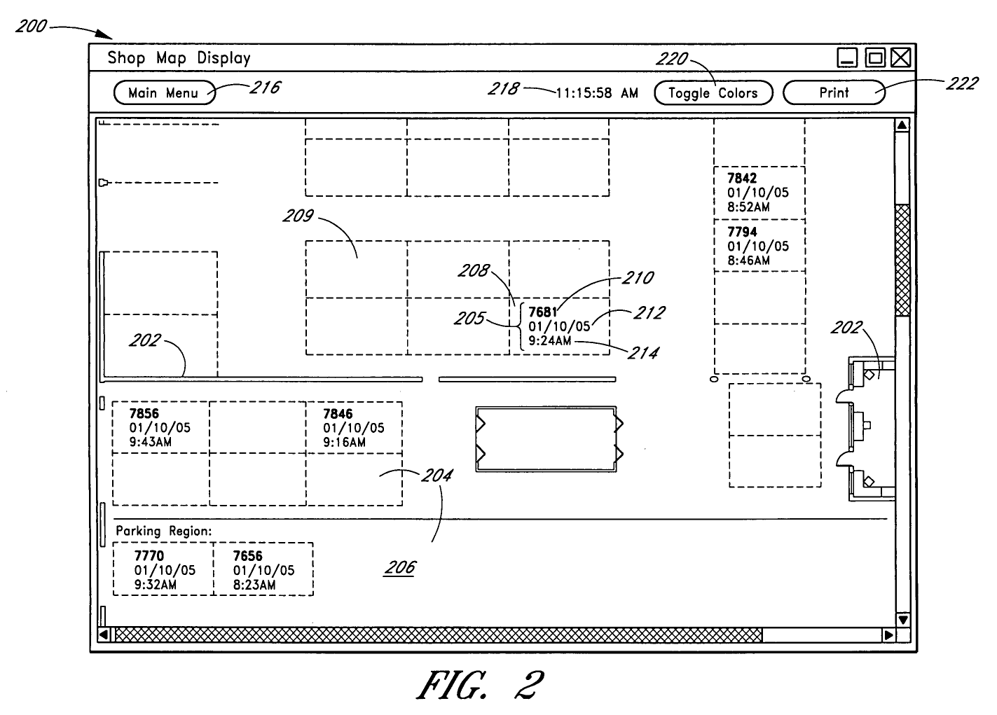

As indicated above, a shop map display can be generated which can be displayed on the workstations 127 or on the display screens 132. FIG. 2 illustrates an embodiment of such a shop map display. A shop map display 200 comprises one or more optional graphical architectural elements 202, one or more map locations 204, and one or more service object status summaries 205.

The optional graphical architectural elements 202 comprise graphical depictions of physical structures that are part of, in, or around the physical service shop 100. The depicted physical structures can include, for example, walls, doors, desks, machines, trees, and any other physical structure known to a skilled artisan. In one embodiment, the graphical architectural elements 202 are stored in an image file such as, for example, a Graphic Interchange Format (“GIF”) file, a Joint Photographic Experts Group (“JPEG”) file, a bitmap (“BMP”) file, or any other image file of any format known to a skilled artisan. As part of generating the shop map display 200, the map locations 204 and service object status summaries 205 are overlaid on the image depicting the graphical architectural elements 202, which serves as a background for the shop map display 200.

Similar to the physical locations 104, the map locations 204 comprise either (1) one or more map regions 206 and one or more map stalls 208, (2) one or more map regions 206 but no map stalls 208, or (3) no physical regions 206 but one or more physical stalls 208. Each map region 206 corresponds to a physical region 106. Each map stall 208 corresponds to a physical stall 108. Preferably, the map stalls 208 are arranged graphically on the shop map display 200 such that the shop map display 200 depicts the geographical relationship between the corresponding physical stalls 108. For example, assuming that the top of the shop map display 200 represents the northern border of the service shop 100, a map stall A located to the left of a map stall B on the shop map display 200 corresponds to a physical stall A that is located west of a physical stall B in the service shop 100.

In one embodiment, the map regions 206 also are arranged on the shop map display 200 such that the shop map display 200 depicts the geographical relationship between the corresponding physical regions 106 and the physical stalls 108. In other embodiments, such as the embodiment of FIG. 2, the shop map display 200 does not depict such geographical relationships. Instead, as illustrated by FIG. 2, each map region 206 may be displayed at a particular portion of the shop map display 200, such as for example, in the bottom left corner of the shop map display 200.

The service object status summaries 205 comprise information that summarizes the status and physical location occupied by a particular automobile or other service object. For example, as shown in FIG. 2, each service object status summary 205 is overlaid and displayed inside one of the map regions 206 or map stalls 208. The shop map display 200 depicts unoccupied map stalls 209 by graphically depicting such stalls with no overlaid service object status summary 205. These unoccupied map stalls 209 correspond to physical stalls 208 in which no automobile is currently located.

The specific information depicted for each automobile can vary. For example, as shown on FIG. 2, the specific information can include a repair order number 210, a date entered indicator 212, and a time entered indicator 214. The repair order number 210 identifies a repair order that is associated with a particular automobile. As previously indicated, in certain embodiments an automobile identification number instead of a repair order number 210 is stored on the tags 116, and in such embodiments an automobile identification number appears in the map locations 204 instead of a repair order number 210. The date entered indicator 212 indicates the date on which the automobile associated with the repair order entered the physical location corresponding to the map location. The time entered indicator 214 indicates the time at which the automobile associated with the repair order entered the physical location corresponding to the map location. Furthermore, because the foregoing information appears inside a particular map location 204 that corresponds to a particular physical location 104, the shop map display 200 also conveys, graphically, the current physical location 104 of the automobile that corresponds to the identified repair order number 210.

In one embodiment, the automobile identification number or repair order number 210 can be color coded to indicate a status for the automobile being serviced. For example, if an automobile is currently where it is supposed to be and the total time spent does not exceed the maximum time that the automobile should remain at its current physical location, the repair order number 210 can be displayed in green. The repair order number 210 can change to yellow if a car exceeds its “Warning Time” or red if the car exceeds the maximum length of time in a physical location. The repair order number 210 can change to purple if the car has exceeded the maximum length of time but a reason for delay has been entered into the system. A skilled artisan will appreciated that other statuses and colors can also be supported.

As discussed above, each service object status summary 205 is overlaid and displayed inside one of the map regions 206 or map stalls 208. In one embodiment, pixel coordinates for each map location 204 are stored in a database, and the stored coordinates are used to determine where the service object status summary 205 should be displayed in order for the service object status summary 205 to appear within the appropriate map location 204. For a shop map display 200 on which each map stall 208 is represented as a rectangle of a uniform size, a single pair of coordinates of one corner of the rectangle, such as the upper-left corner, suffices to determine where the service object status summary 205 should be displayed. Rectangles of differing sizes or irregular shapes for map stalls 208 can also be supported, provided that a sufficient number of pixel coordinate pairs are stored in a database and used to ascertain the shape of each map stall 208 and where it is on the shop map display 200.

In one embodiment, each map region 206 has a defined upper-left coordinate but has no pre-defined size. Rather, each map region 206 grows in size to accommodate the number of automobiles that must be displayed within the map region 206. For example, as illustrated “Parking Region” 206 shows that two automobiles are in the region 206 because two service object status summaries 205 are depicted therein. If a third automobile were to enter the corresponding physical region 106, the size of the map region 206 would expand to include a third cell, to the right of the existing cells, in order to accommodate the new service object status summaries 205. Similarly, if several automobiles, such as six automobiles, entered the corresponding physical region 106, the map region 206 may expand both to the right and downward in order to accommodate the added automobiles.

In certain alternative embodiments, the shop map display 200 presents additional features. For example, the shop map display 200 may include a main menu button 216 for accessing the software's main menu. The shop map display 200 may include a current time indicator 218. The shop map display 200 may include a toggle colors button 220 that allows a user to change the colors displayed on the shop map display 200. The shop map display 200 may include a print button 222 that allows a user to print the shop map display 200.

In one preferred embodiment, the shop map display 200 is configured such that a user can select at least one of the service object status summaries 205 in order to view more detailed information about the selected service objects. For example, a user may be presented with a Car Information report, as described in more detail below in the section entitled “Car Information Module,” when the user clicks on a hypertext link associated with a particular service object status summary 205. The shop map display 200 can be additionally or alternatively configured to allow a user to invoke a number of other functions by selecting at least one of the service object status summaries 205. For example, the shop map display 200 may be configured to perform one or more of the following functions when a user selects one of the service object status summaries 205: (1) update the status information for the automobile identified in the service object status summary 205, including, for example, the object's physical location, (2) associate a service process with the automobile, (3) modify a previously associated service process, (4) enter a reason why the automobile has been delayed in the current physical location, (5) import status information from third party sources, (6) import repair time estimates from third party sources. The shop map display 200 may also be configured to perform one or more alternative or additional functions not explicitly listed but which will be appreciated by a skilled artisan in light of this disclosure.

Service Processes

In one embodiment, in addition to being associated with a unique identifier encoded on a tag, each automobile is also associated with a service process. A service process defines one or more steps that are performed in order to service an automobile or other service object. Each step of a service process may be associated with one or more physical locations. Accordingly, a service process can be used to define an ordered list of physical locations that an automobile must visit in order to be serviced. A skilled artisan will appreciate, in light of this disclosure, that a variety of service processes exist, and that the steps and physical locations differ for each kind of service process. For example, a simple service process such as touching up chipped paint may involve only a single step and physical location, such as painting in a paint room. A more detailed service process, such as body work, may include many steps and physical locations, such as, for example, tear down, mechanical, bondo, painting, and reassembly.

Preferably, the system includes one or more service process modules for defining service processes and for associating a service process with a particular automobile. Such service process modules can be located on the client workstations 128 or on the server 127.

FIG. 1B is a flowchart that illustrates a service process. A service process 160 comprises one or more service steps 162, shown in the figure as “General Service Categories.” The General Service Categories 162 may encompass one or more groupings of physical locations that an automobile must visit during the service process. For example, the General Service Category 1 comprises three groupings 164, 166, and 168, with each grouping having one physical location that must be visited. As shown, the groupings 164, 166, and 168 are arranged such that the physical locations are visited in serial fashion. The General Service Category 4 comprises three groupings 170, 172, and 180, which are also arranged serially. However, the grouping 172 comprises three physical locations 174, 176, and 178, which are arranged in parallel. That is, not every one of the physical locations 174, 176, and 178 needs to be visited in order; each automobile visits only one of the physical locations 174, 176, or 178. The ability to arrange groupings and physical locations either serially or in parallel allows an administrator to define service processes with a great deal of flexibility. A serial set of groupings, such as, for example, the groupings 164, 166, and 168, corresponds to a service process in which only one physical location exists at each step and an automobile must visit each physical location. A parallel grouping, on the other hand, corresponds to circumstances in which multiple physical locations exist for a particular step, such as for example, a paint room A, a paint room B, and a paint room C, and the automobile needs only visit one of them.

Preferably, information about the service processes associated with each automobile assist in generating many reports and forecasts, as explained below in the sections regarding reporting and forecasting. For example, service processes are used to determine where each automobile must go to complete its service process. Similarly, the service processes are used to determine which physical locations are projected to be occupied at given times, how many automobiles are in line for a particular physical location, and the like. The foregoing information is used to determine calculate estimated times that each automobile will be in each physical location and estimated times for completion of each service process. Advantageously, this information can provide detailed status information to workers at the service shop 100 and customers.

Reporting Features

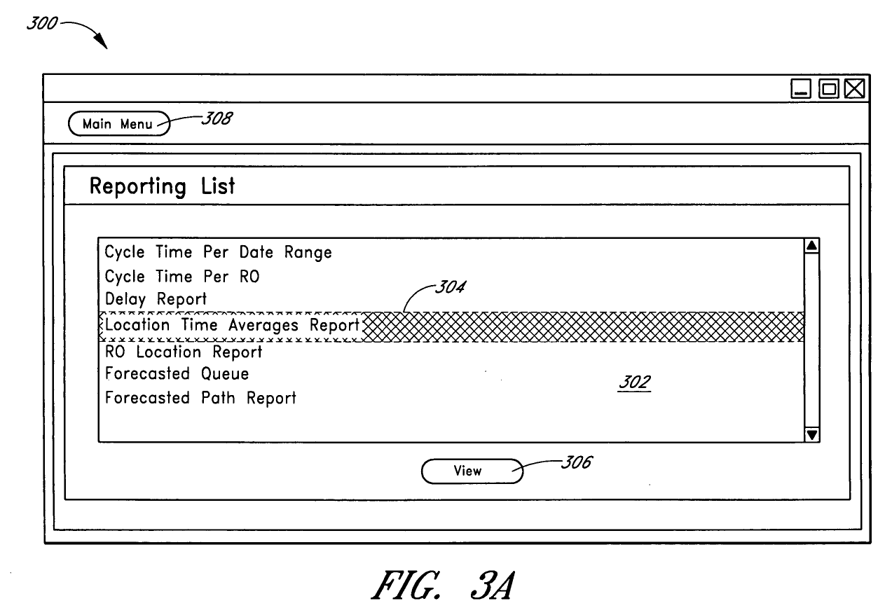

Preferably, the workstations 128 include a reporting module that generates a number of useful reports based on the information stored in the databases maintained by the servers 127. FIGS. 3A and 3B illustrate one such report, a “Location Time Averages Report.” A user uses a report selector user interface 300 in order to select a specific report for viewing. The report selector user interface 300 comprises a report list 302 listing available reports, a report selector indicator 304 which indicates which report has been selected by the user, an optional report view button 306 which, when selected, instructs the workstation 128 to generate and display the selected report, and an optional main menu button 308 which, when selected, instructs the workstation 128 to present the software's main menu to the user.

As illustrated in FIG. 3A, the user has selected the “Location Time Averages Report,” causing the workstation 128 to generate and display the report illustrated in FIG. 3B. As illustrated, the “Location Time Averages Report” shows for a number of physical locations the number of automobiles that have entered each particular physical location during a specified time period, the aggregate time that the automobiles have been in each physical location, and the average time spent per automobile per physical location.

The report is displayed in a report user interface 310. The report user interface 310 allows a user to specify a number of input parameters 312. As illustrated, the input parameters 312 can include a beginning date, an ending date, and a selection of the physical locations for which the report will be generated. A view report button 313, when selected, instructs the workstation 128 to generate the report using the specified parameters. The user can navigate through the report results using a number of report navigation tools 314. The user can export the report to another software package, such as, for example, Microsoft Excel, using an export tool 316. Report results are displayed in a result portion 318. A main menu button 320 allows a user to instruct the workstation 128 to run the software's main menu. A reporting button 322 allows a user to instruct the workstation 128 to return to the software's report list, illustrated by FIG. 3A.

The system can be configured to generate many other reports. This application describes some of these additional reports below in the section entitled “Report/Forecast Module.”

Repair Status Web Access

Preferably, the servers 127 include one or more web servers that allow a customer to view status information regarding a repair using a web browser. FIGS. 4A and 4B illustrate such an advantageous feature. The web servers of the servers 127 serve to a customer's web browser a repair status web page 400. The repair status web page 400 includes a user login dialog box 402 and a customer automobile lookup dialog box 404. A user uses the user login dialog box 402 in order to log into the repair status web access service. The web servers of the servers 127 can enforce any security mechanism known to a skilled artisan in order to ensure authorized access by an actual customer. After logging in, the customer can use the customer automobile lookup dialog box in order to select the service shop at which the customer's automobile is being serviced and a repair order number or automobile identifier. Upon receiving such customer selections, the web servers generate a status information web page 420, illustrated by FIG. 4B. The status information web page 420 displays customer information 406, a repair order number or automobile identifier 408, automobile identification information 410, a task list 412 which includes a history of the physical locations that the automobile has visited, together with the date the automobile was at each physical location, and a delay list 414 which includes notes, if applicable, that describe any delay that has occurred in the servicing of the automobile. The task list 412 may include, in addition to physical locations that the automobile has already visited, a list of physical locations that the automobile is scheduled to visit, together with an expected time and/or date that the automobile is scheduled to be at the future physical location. The task list 412 may also indicate an estimated time or date that the service process is expected to complete. A done button 416 allows a user to indicate to the web server that the customer has finished looking at the status web page 420.

Additional web access features can also be provided. For example, an embodiment of a service shop 100 can have video cameras or still cameras positioned at certain physical locations 104 throughout the shop 100. Such video cameras or still cameras can provide images depicting the service that is being performed at such locations. These images can be stored in digital format using any suitable digitizing mechanism and any suitable digital image format known to a skilled artisan. The server 127 can be configured to determine at which location a particular customer's automobile resides and, if the location has a camera with images of that location, to cause the web server 528 to serve still images or video to the customer's web browser. As another example, a web access feature can be provided that allows a customer to approve or reject proposed service activities. For example, in one embodiment, service activities that have been proposed but have not been approved by the customer can be displayed to the customer's web browser 512 when the customer is logged in. A dialog box or other selection tool can also be displayed to receive the customer's input. For example, the dialog box may include an “approve service” button and a “reject service” button. If the customer selects the “approve service” button, the proposed service activities can be added to the service object's service path and the service can be performed. If the customer selects the “reject service” button, the proposed service activities will not be performed. The web server 528 can be configured to support any suitable payment mechanisms for receiving payments from customers, such as, for example, credit card processing systems and the like. How to implement and use these and other features will be appreciated by a skilled artisan in light of this disclosure.

Advantageously, the web access features described above can allow a customer to access information about a service object using any web browser connected to the Internet. Thus, the customer can access this information from home, from a laptop or public computer while traveling, or the like. Alternatively, the web access features can be accessed from a limited or controlled group of web browsers. For example, in one embodiment the web access features can be made available only from web browsers that have stored, in a cookie or other mechanism, a security code. A skilled artisan will appreciate that other mechanisms for restricting the web access features to particular web browsers can be employed.

Network Architecture

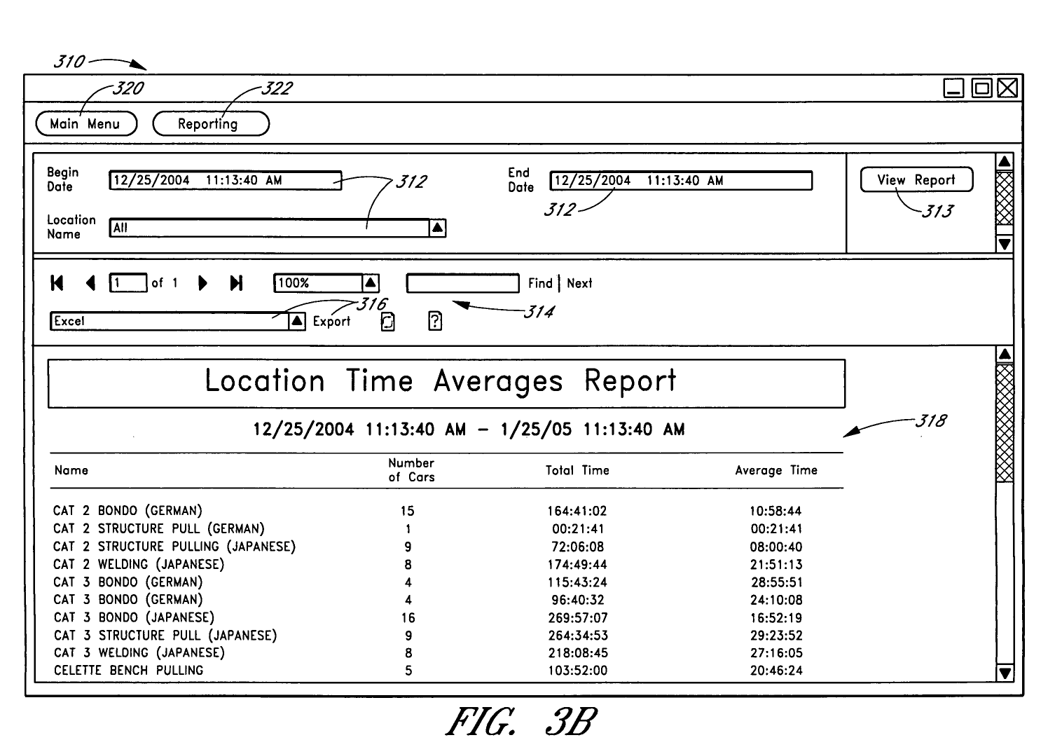

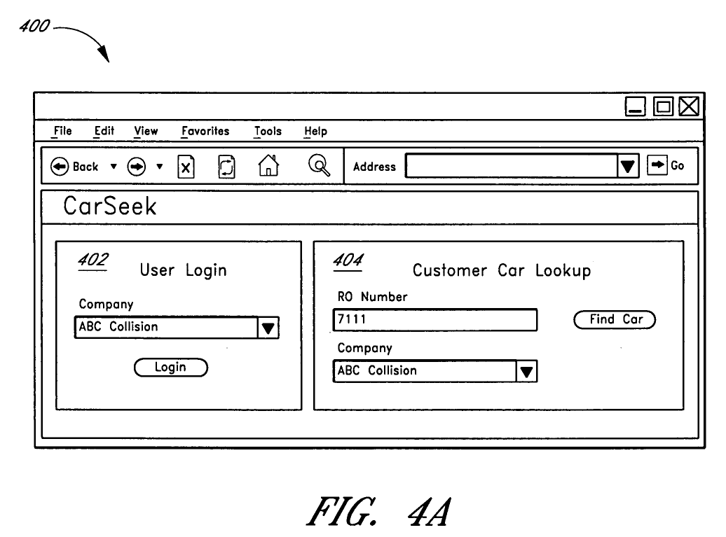

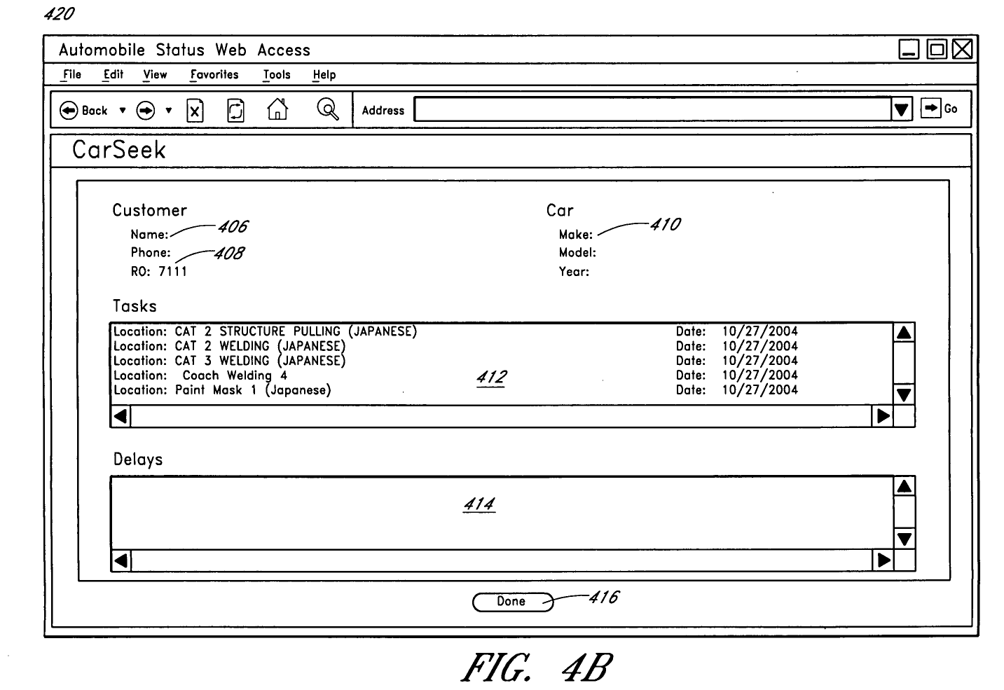

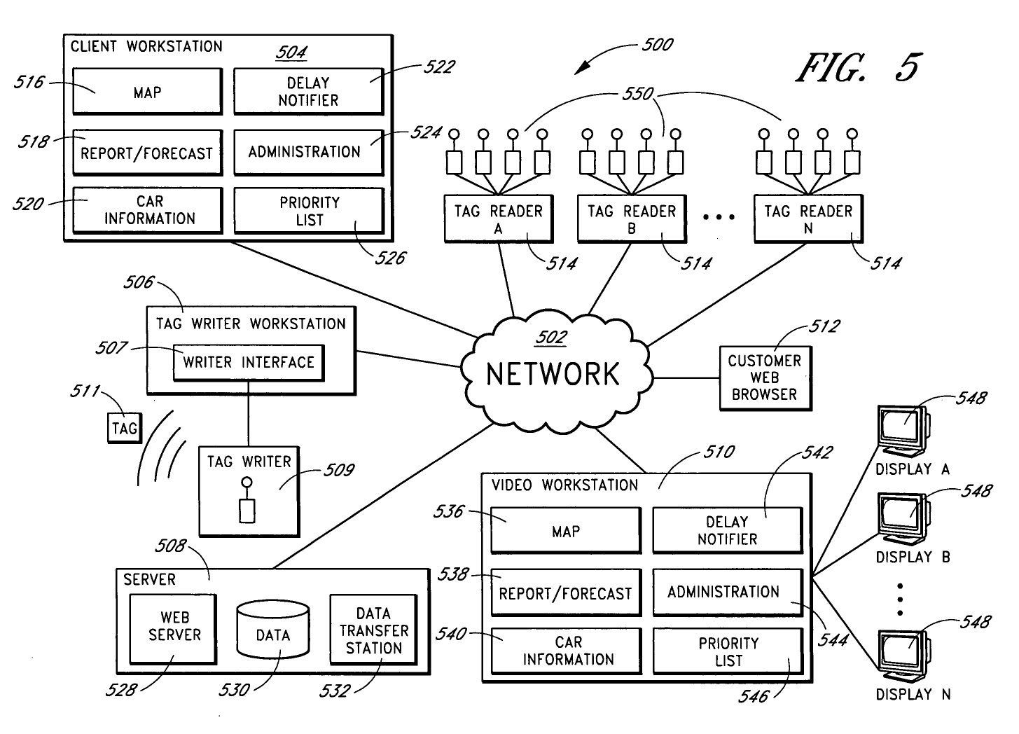

FIG. 5 illustrates one embodiment of a network architecture for implementing the system and method described herein. In a network architecture 500, one or more client workstations 504, one or more tag writer workstations 506, one or more servers 508, one or more video workstations 510, a customer web browser 512, and one or more tag readers 514 are connected to each other via a network 502. In one embodiment, the network 502 is configured such that each computer or device connected to the network 502 can communicate with each of the other computers or devices connected to the network 502. This, however, is not required.

Client Workstations

Each client workstation 504 comprises one or more modules chosen from a map module 516, a report/forecast module 518, a car information module 520, a delay notifier module 522, an administration module 524, and a priority list module 526. Each of the modules is configured to perform one or more functions as described below. While each of the described modules perform advantageous functions, a skilled artisan will appreciate, in light of this disclosure, that one or more of the modules may be omitted from certain embodiments while still remaining within the scope of the invention. For example, in one embodiment, the client workstation 504 has the map module 516, the report/forecast module 518, and the car information module 520, but omits the delay notifier module 522, the administration module 524, and the priority list module 526. Every other possible combination of one or more of the described modules defines an embodiment of the client workstation 504.

Map Module

The map module 516 is configured to generate and display the shop map 200 as illustrated by FIG. 2. The map module 516 can optionally be configured to also print the shop map 200. The map module 516 generates the shop map 200 from graphical layout information representing the layout of the service shop 100 and information concerning current physical locations of service objects within the service shop 100. The graphical layout information may be stored as an image file within the server data 530. The graphical layout information may alternatively or additionally be stored locally in the client workstation 504.

Report/Forecast Module

The report/forecast module 518 is configured to generate and display or print a variety of reports and forecasting information. As described above, FIGS. 3A and 3B illustrate a user interface for the reporting function of the report/forecast module 518 and a “Location Time Averages Report” that the report/forecast module 518 can generate. Additional reports may also be available, as follows.

A “Cycle Time Per Date Range” report accepts a date range as input and lists every car that arrived or departed the service shop 100 during that date range. This report displays, for each car, the repair order number or car identifier, the arrival date, and the departure date.

A “Cycle Time Per Repair Order” report accepts a repair order number or car identifier as input and lists every site visit for the specified repair order number or car identifier. The repair order number or car identifier, arrival date, and departure date are displayed.

A “Delay Report” displays all delays that occurred during a specified date range. This report displays each physical location at which a delay occurred, the repair order or car for which the delay occurred, and the date and time of each delay.

A “Repair Order Location Report” accepts a repair order number or car identifier as input and displays a listing of all the physical locations that the associated car visited. This report displays each physical location, time entered, time exited, total time, maximum time, repair order number or car identifier, and responsible user. A “responsible user” can be a person that oversees and is responsible for a repair process for a repair order. The responsible user oversees the process, makes sure that a car moves through the process, and responds to any delays that may occur. In alternative embodiments, more than one responsible user can be designated for each repair order. “Maximum time” refers to a guideline for the maximum amount of time that a car should be at the physical location.

A “Forecasted Queue Report” displays a listing of each of the general service categories that a car can visit. A “general service category” defines one or more physical locations that a car must visit during a particular step in a service process. Example general service categories, each of which corresponds to a step in a service process, are a “tear down” general service category, a “bondo” general service category, a “mechanical” general service category, and the like. For each general service category, this report also lists a forecasted queue showing the first-in-first-out order in which cars are projected to enter and leave the physical locations within the general service category.

A “Forecasted Path Report” accepts a repair order number or car identifier as input and returns a forecasted service path that the associated car is projected to take through the service shop 100. The system can calculate the forecasted path in accordance with the following procedure: Forecasted service paths can be predefined by an administrator and can be customized for each service shop. When an object is tagged a service path is chosen for the object. In some cases, it may be possible to assign an object to one of several alternative service paths. In one embodiment, a default service path is designated, and is assigned to an object when a different service path is not chosen.

The total time the service process will need to be completed can be calculated by taking a summation of location wait times for each location the object will visit and location service times for each location the object will visit. In some cases, an object's service path may define alternative parallel locations that may be visited at a given step in a service process. For example, this may occur when an object must be painted, but needs to visit only one of three paint rooms. In such a case, the procedure can use the shortest possible wait time of the alternative locations in performing the calculation. Alternatively, the procedure can use one or more of the longest possible wait time, an average of all possible wait times, or an expected wait time.

The service time for a location can be calculated by adding together the maximum service time for the location and the times for any events that are scheduled to occur during the time period that the service object is expected to be at the location. The service time can alternatively be calculated using expected service time or average service time in place of maximum service time. “Events” define time periods during which a location is not being used for service, such as, for example, break times, evenings for service shops that close each evening, holidays, and the like.

The wait time for a location can be calculated by summing the service time for all service objects that are in line in front of the current service object for the specified location. The service time used for such a summation can be a maximum service time, an expected service time, an average service time, or the like.

The above calculations include the locations that have yet to be visited by a particular service object, as locations already do not impact the total service time, going forward, that an object is expected to remain in the service shop 100. In one embodiment, however, forecasts can be maintained in the system to gauge performance and produce productivity reports. For example, one report can compare average projected total service time with average actual total service time to gauge whether the service shop 100 is meeting performance expectations.

The report/forecast module 518 generates the reports from information stored in the server data 530. Alternatively or additionally, some or all of the information can be stored on the client workstation 504 or on some other computer or device connected to the network 502.

Preferably, the foregoing reports and other reports present information that is useful to allow a repair shop 100 to perform its servicing functions better and more profitably. In order to achieve this advantage, the server data 530 preferably stores suitable underlying information with which useful reports can be generated. Such suitable underlying information may vary depending on the type of service object serviced by a particular service shop 100. Such variations will be appreciated by a skilled artisan in light of this disclosure. By way of illustration and not limitation, below are certain types of information that are generally useful for many service shops.

(1) Location Time: One purpose of tracking the physical location of a car or other service object in a service shop or storage yard is to maximize profit over time. A service shop can increase profits per set period of time if the service shop can move more cars through the shop in the set period of time. Accurate tracking of a vehicle in a storage yard enables better accounting. In both cases, most service shops want to know how much time each object spends in a stall or region. Furthermore, most service shops want to establish and track goals for moving objects through physical locations quickly.

Preferably, the server data 530 includes a maximum time value for each physical location, representing the maximum amount of time that an automobile should remain in the given physical location. The system is able to track, for each physical location, both how long the car has been in the current physical location and how long the car should be in the current physical location. When a car is first detected at a physical location it is given a green status, meaning that the car is currently where it should be and that the total time spent does not exceed the maximum time that the car should remain at this physical location. As described below, this status can change to yellow if a car exceeds its “Warning Time” or red if the car exceeds the maximum length of time in a physical location.

There are two ways the maximum time value can be entered into the system. A user can enter the value manually. Values entered manually for a physical location set a standard for any car at that physical location. Preferably, this standard represents an average time at the physical location per car. However, the standard does not take into account differences in the level of damage or other circumstances. In order to take advantage of different circumstances for each car, the maximum time can be entered on an individual car basis. In one embodiment, this is done importing a physical location-by-physical location estimate for an individual car from an Estimate Management System (“EMS”) file or similar electronic source. The system extracts the time estimates from the EMS file and applies them to each physical location for the specific car. In some cases, service shops are set up in a way that multiple stalls take the place of a single EMS category. For example, a service shop may have three different stalls for “Metal Repair.” To account for such cases, the system maintains a percentage for each stall in a multi-stall category that reflects the percentage of estimated time that the car is expected to spend in each of the stalls. When the system receives a total estimate for “Metal Repair,” the system automatically calculates, using the percentages, a time estimate for each of the individual “Metal Repair” stalls.

In addition to entering individualized car estimates by importation, an embodiment of the system provides a manual entry tool for entering estimates physical location-by-physical location, car-by-car.

(2) Warning Time: When a physical location is configured with a set amount of time for a car to remain at that physical location, another time known as the “Warning Time” can be entered into the system. This time, preferably set at some value below the maximum time, allows the system to notify managers or technicians that the car should be moving on shortly. The warning time alerts all involved that the car will soon exceed the time it should stay at the current physical location. Once the car at a physical location enters the warning time phase, the car status is changed to yellow to indicate that urgency is needed.

(3) Delays: If a vehicle has remained at the current physical location beyond the specified maximum time for the physical location, the status of the car turns red. The red status notifies the manager and technician that the vehicle has surpassed the time allowed. At this point a delay entry is made and the manager that has responsibility for the vehicle is notified. The manager can then address the issue and make a delay entry specifying what caused the delay and what has been done to expedite the process. After a delay entry is made, specifying a reason and solution, then the car status will turn purple. This notifies all involved that the car should move on, but the reason that it has not moved on has been addressed.

(4) Cycle Time: The total time a vehicle is at a facility is known in the repair industry as “cycle time”. The cycle time is tracked from the moment the tag is assigned the unique identification number, until the vehicle leaves the facility and the tag is optionally removed from the vehicle. Tracking the cycle time allows for improved reporting that includes the total time a car took to be repaired, or in a storage yard, the total time that the vehicle was stored. Additionally, in a service shop the total time a vehicle was at the facility can be compared to the total work time on the vehicle, which will provide a better insight to possible improvements in the repair process.

Car Information Module

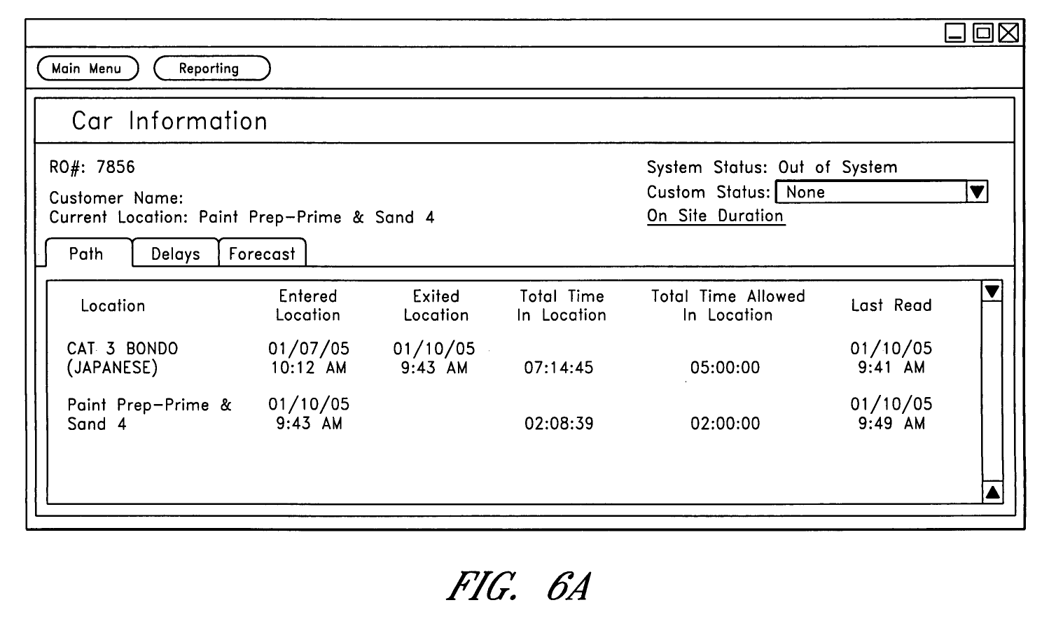

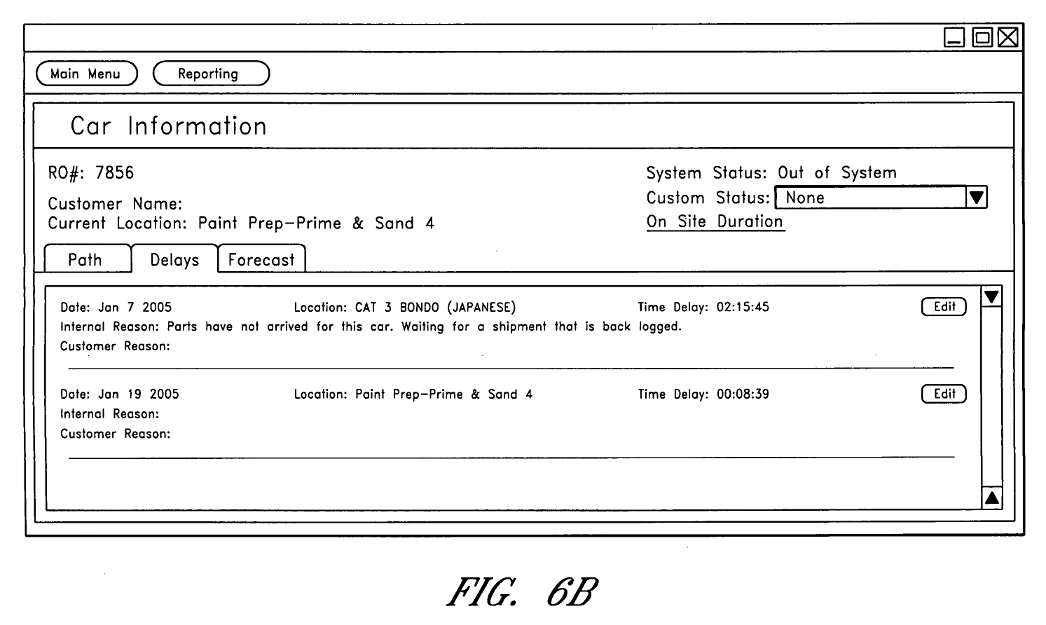

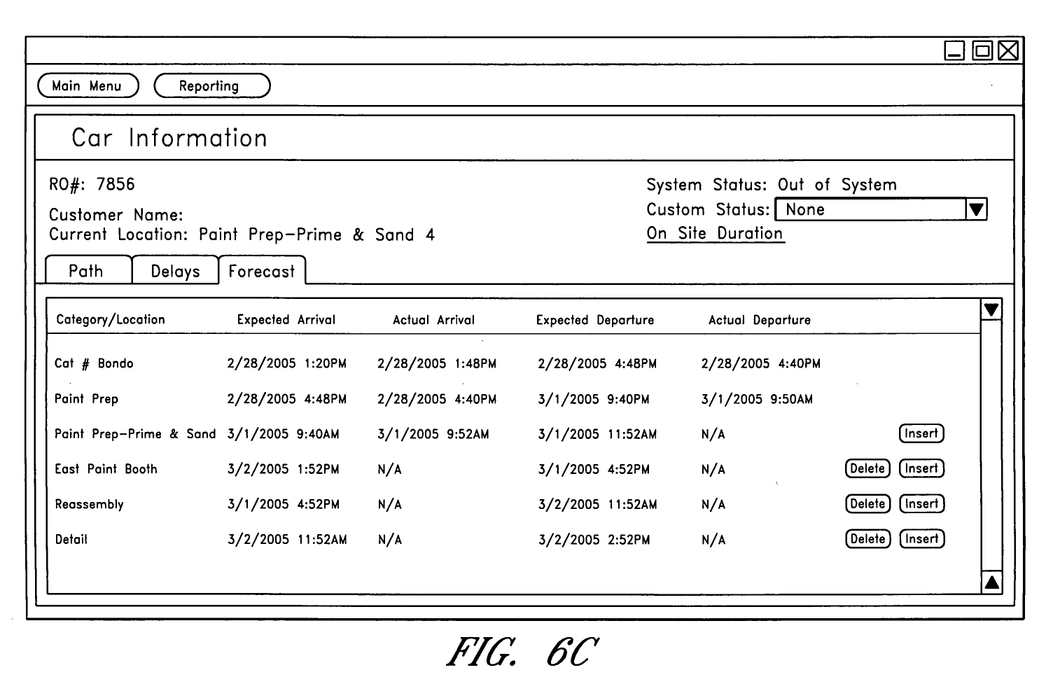

The car information module 520 generates and displays information specific to a given car that entered the service shop 100. For service shops 100 that service objects other than cars, the car information module 520 can be an object information module 520. FIGS. 6A, 6B, and 6C illustrate the information that can be displayed by the car information module 520. FIG. 6A shows a service path listing showing the path that a particular car has taken through the service shop 100. FIG. 6B shows information regarding any delays that have occurred in the process of servicing the car. FIG. 6C shows a forecast of a car's service path, including physical locations that car has visited, the current physical location of the car, and physical locations that the car is projected to visit, together with expected arrival and departure times for each physical location. The expected arrival and departure times are derived by determining, for each physical location, how many cars are in line to visit the physical location, the order in the queue that the selected car occupies for each physical location, and the expected time that each car will spend in each physical location. The expected time that each car will spend in each physical location is stored as a value, for each physical location, in the server data 530. This value can be assigned by a user, assigned by an automated process, or can be calculated. For example, in one embodiment in which the expected time that each car will spend in each physical location is calculated, the expected time is set to the average time that each car has spent in each physical location over a specified period of time.

The car information module 520 generates the foregoing information from information stored in the server data 530. Alternatively or additionally, some or all of the information can be stored in the client workstation 504 or any other computer or device connected to the network 502.

Delay Notifier Module

The delay notifier module 522 is configured to detect delays that have occurred in a service process and to generate notifications when such delays occur. The delay notifier module 522 detects such delays using information stored in the server data 530, including, for example, the current physical location of each car, the time each car entered the current physical location, the current time, and the maximum time allowed for each car in a given physical location. Advantageously, the maximum time allowed for each car in a given physical location can be set or modified by a user, an automated process, or can be calculated. The delay notifier module 522 periodically performs a calculation to determine whether a delay has occurred, comparing the length of time each car has been at its physical location with the maximum time allowed for each car in the given physical location. If a car has exceeded this maximum time allowed, the delay notifier module 522 detects a delay.

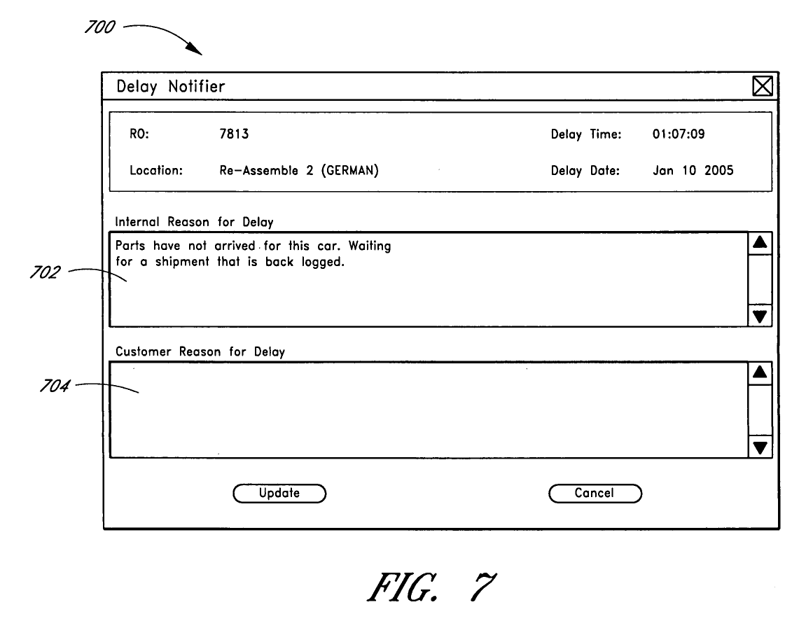

Upon detecting a delay, the delay notifier module 522 generates a delay notification, such as, for example, a pop-up window. Preferably, the delay notification provides a dialog box or other input means to allow a user or automated process to enter a reason for the delay. Such a dialog box 700 is shown on FIG. 7. The delay notification can allow a user or automated process to enter more than one reason, such as, for example, the illustrated internal reason for delay 702 and the customer reason for delay 704. Advantageously, providing an internal reason for delay 702 and a customer reason for delay 704 allows a service shop 100 to maintain an internal reason for a delay that may have more information than is desirable to share with a customer. For example, it is generally undesirable to share overly technical reasons with a customer, particularly when such reasons are likely to confuse more than assist a customer.

In certain embodiments, the information the delay notifier module 522 uses to detect delays is stored in the server data 530. Some or all of this information can alternatively or additionally be stored in the client workstation 504 or any other computer or device connected to the network 502.

Administration Module

The administration module 524 comprises various management functions including user management, group management, location management, team management, department management, event management, status management, and car information management.

The user management sub-section enables an administrator to create, delete, and modify user accounts. Administrators can also assign access permissions to users according to their group membership.

The group management sub-section enables an administrator to create, delete and modify user groups. Administrators can also assign user membership to the groups and group access permissions.

The location management sub-section enables an administrator to add, delete, and modify location information corresponding to physical locations. For example, the administrator can set a default warning time and a maximum allowed time for a physical location. A default warning time can be used by the system to detect when a car has been in a physical location for nearly its allotted time for the physical location. Based on such detection, a notification can be generated to encourage finishing the service activity at the particular physical location so that the car can proceed as quickly as possible through the service process. A maximum allowed time is a guideline that indicates how long each car should be in a particular physical location. If a car exceeds such a maximum time, a delay has occurred. The delay notifier module 522 uses the maximum allowed time, along with other information, to detect and report such delays. The administrator can also configure a location type, a location name, and a hardware profile address. A hardware profile address comprises information about which tag reader 514 is associated with each physical location.

The team management sub-section enables an administrator to create, delete, and modify team organizational units. A team is an organizational unit that uses one or more physical locations. For example, a domestic team that works on domestic cars may use several physical locations used for various service activities on domestic cars, such as domestic tear-down, domestic bondo, domestic painting, and the like. The administrator can assign which physical locations belong to each team, can name each team, and the like.

The department management sub-section enables administrators to create, delete and modify department organizational units. A department is another organizational unit that uses one or more physical locations. A department uses physical locations that are functionally related to each other in that each physical location is used to perform a related service activity. For example, a paint department may have a number of physical locations used for painting, such as Paint 1, Paint 2, Paint 3, and the like. The administrator can assign which physical locations belong to each department, can name each department, and the like.

Advantageously, providing two different organizational units that comprise teams increases an administrators flexibility in relating physical locations to each other. Teams may be used to group physical locations that are used to service a class of cars, such as foreign or domestic, without regard to how related the service activities performed at each physical location are. Departments maybe used to group physical locations that are used for the same general type of service, such as, for example, the paint department, mechanical department, and the like.

The event management sub-section enables administrators to create, delete, and modify system events. System events are scheduled time periods that are not counted towards the total time that a car is at a physical location, team, or department. The event management sub-section enables the administrator to specify the specific time periods that are not counted towards the total time a car is at a physical location, team, or department. The administrator can also specify to which physical locations, teams, or departments the event applies. Preferably, the scheduled time periods correspond to time periods in which productivity is not being lost because of the car's presence in the physical location. For example, at times in which no worker is scheduled to work, such as, for example, between midnight and 3:00 am, no productive time is being wasted because a car is sitting idle in a particular stall. Other examples are holidays that all workers have off from work, break times that everyone takes, and the like. Productive time is wasted during non-event times, such as when a car sits too long in an active stall during the workday on a non-holiday. It is advantageous to be able exclude certain time periods for reporting purposes because so that time spent by a car at a physical location when no productive time is wasted do not skew reports that a manager may use in order to judge a particular team or department for efficiency.

The status management sub-section enables administrators to create, delete, and modify status information for each car. The status information is displayed on various screens of the application in order to inform users about status of a car that is not captured by location information automatically captured by the system. Such status information can include notes such as, for example, “Call the Customer,” “Car Needs a Wash,” “Customer is Waiting,” and the like.

The car information management (or object information management) sub-section enables administrators to create, delete, and modify custom data fields displayed by the car information module 520. Such custom data fields can include, for example, “Closing Notes,” “Customer Requests,” or the like. After such custom data fields have been entered, users can add information for each car into the data fields.

In certain embodiments, the information created, accessed, and modified by the foregoing administration sub-sections is stored in the server data 530. Alternatively or additionally, such information can be stored on the client workstation 504 or on one or more other computers or devices connected to the network 502.

Priority List

The priority list module 526 generates and displays or prints a list of all cars or other objects currently in the system and being tracked. The generated lists include a repair order number or car identifier, customer identification information, current physical location, total time in the physical location, and custom status. In addition, the priority list module 526 preferably allows a user to select a particular car listed on the priority list in order to view more detailed information about the car, such as generated by the car information module 520. In one embodiment, when a user selects a car from the priority list, the priority list module 526 invokes the car information module 520 and the car information module 520 displays detailed information about the car.

Technical Details of Embodiments of the Client Workstations

This section comprises a description of technical details for embodiments of the client workstations 504. This is only one specific embodiment that does not limit the invention. In one embodiment, a client workstation 504 connects to the server 508 via a folder share to a HyperText Markup Language Application (“HTA”) file that resides on the server. The application then runs on the client workstation 504 in an Internet Explorer HTA window. The client workstation 504 can, if a user desires, run only the delay notifier module as a local background application. Optionally, the client can also connect to the web access website in order to run the application in a web browser over the Internet.

Preferred hardware for this embodiment is a server running Windows 2003 Server with a Microsoft SQL Server database and Internet Information Services 6.0. The server is connected via the internal network by a Microsoft folder share. The client workstation runs Windows XP Professional. The client workstation has Internet Explorer 5.1 service pack 2 or later. The delay notifier module runs as a windows application using the .Net Framework 1.1. The delay notifier module connects to the server data 530 over the internal network and runs as a service in the system tray of the computer.

Tag Writer Workstation

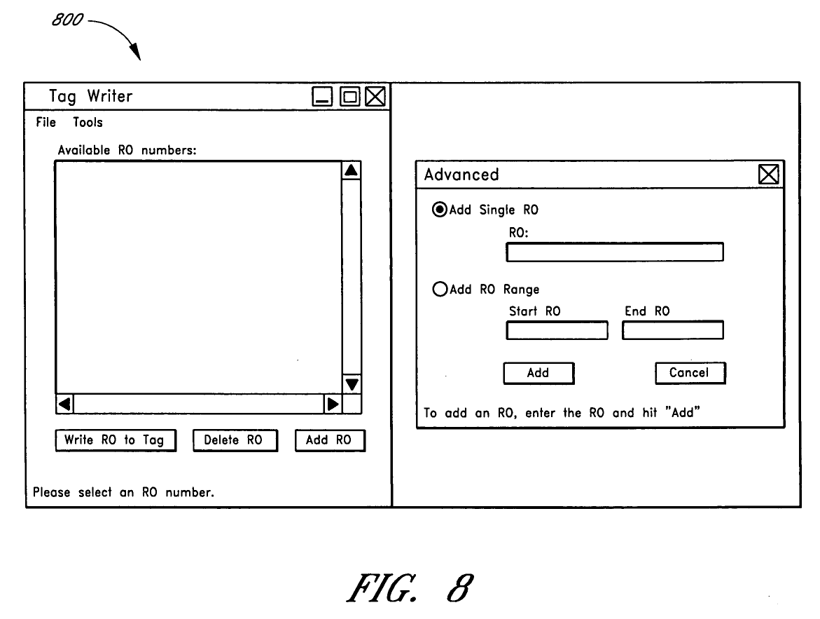

The tag writer workstation 506 comprises a writer interface module 507. The writer interface module 507 is configured to communicate with a tag writer 509. The tag writer 509 has an antenna for transmitting information to a tag 511. The information transmitted from the tag writer 509 to the tag 511 is recorded on the tag 511. The tag 511 is then configured to transmit the recorded information to the tag readers 514. FIG. 8 illustrates a user interface for the writer interface 507. As illustrated, the writer interface user interface 800 presents a list of available repair order numbers or car identifiers. A user can select a repair order number or car identifier and use the user interface 800 to instruct the writer interface 507 to write the selected repair order number or car identifier to a tag. A user can also add repair order numbers or car identifiers to the system. The user can add the repair order numbers or car identifiers one at a time or as a range of repair order numbers or identifiers. When a user selects “Write RO to Tag” or a similar button or selection tool, the writer interface 507 communicates with the tag writer 509 and instructs the tag writer 509 to write the selected repair order number or car identifier to the tag 511. An automated process can, in some embodiments, perform the user functions described above.

This and the following paragraph describes certain technical details that apply only to certain embodiments of the tag writer workstation 506 and the tag writer 509. These invention is not limited to these embodiments. The tag writer interface acquires a list of identification numbers from the server data 530. A user selects the identification number that is to be written to the tag 511. The tag writer interface 507 communicates to the tag writer 509 either through TCP/IP addressing or over a serial port. The tag writer 509 receives the “write” command and the data to be written. The writer 509 transmits the write command and data to be written via radio frequency or other wireless transmission to the tag within local proximity to the writer's antenna.

Preferred hardware for these embodiments is a server running Windows 2003 Server with a Microsoft SQL Server database. The tag writer workstation 506 is connected via the internal network and runs Windows XP Professional. The tag writer workstation 506 has Net Framework 1.1 installed in order to run the writer interface 507. The preferred communications medium is a serial port using an RS232 interface. A CAT5 to RS232 interface can also be utilized for TCP/IP communications rather than serial port communications. The preferred writer is a Texas Instruments Series 2000 Reader with RS232 interface and stick antenna. The tag writer 509 is the combination of the above-mentioned components in a wood housing that allows for a plastic marker hat to rest firmly thereon. The plastic marker hat has a 85 mm Read/Write transponder tag attached to the top.

The writer interface 507 uses the ASCII Protocol as described by Texas Instruments to communicate with the writer 509. The writer 509 functions as described by Texas Instruments for writing to a read/write transponder. When the write process finishes successfully, the tag 511 has in memory the identification number that has been assigned.

Server

The server 508 comprises an optional web server 528, server data 530, and a data transfer station 532. In embodiments that support customer web access for status information, the web server 528 communicates over the network 502 with a customer web browser 512 in order to provide status information, respond to customer requests, and the like. The server data 530 comprises any suitable data storage for maintaining the information about maps, service objects, physical locations, teams, service processes, departments, hardware, users, and the like that the system uses to track service objects, generate and display reports, detect delays, and the like. Preferably, the server data 530 comprises one or more databases which may be managed by one or more database management systems. Additionally or alternatively, the server data 530 can comprise one or more files stored in and managed by any file system known to a skilled artisan.

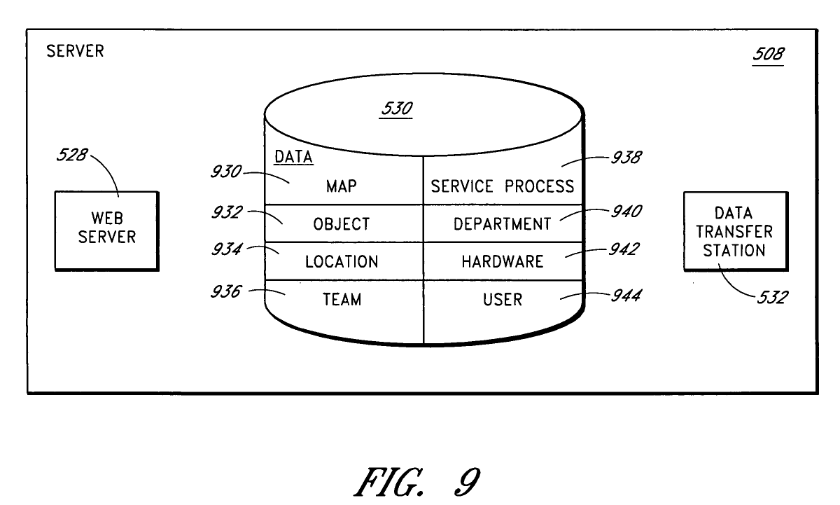

FIG. 9 illustrates the server 508 and particularly illustrates the type of data stored in the server data 530. As shown, the server data 530 comprises data chosen from the categories map data 930, service object data 932, location data 934, team data 936, service process data 938, department data 940, hardware data 942, user data 944, and the like. Map data 930 comprises information from which to generate the shop map 200. Service object data 932 includes detailed information about the service objects that have entered the service shop 100, such as, for example, an identification number, a model name or number, a year of manufacture, information about the problem being serviced, and the like. Location data 934 comprises information about a physical location in the service shop 100, such as, for example, a name for the physical location, a maximum allowed time for service objects to be in the physical location, a capacity for the physical location indicating how many service objects can occupy the physical location, and the like. The location data 934 can also include information that indicates where each tag reader 514 and antenna is located within the service shop 100. For example, in embodiments in which each stall has an antenna of a tag reader 514 dedicated to the stall, a record may exist for each stall that identifies the antenna by tag reader number and antenna number. This information is used by the server 508 to determine, based on readings received from the tag readers 514, the physical location of each object in the service shop 100.

Team data 936 comprises names of teams, which physical locations belong to each team, and the like. Service process data 938 comprises information that defines steps that are performed in order to service an automobile, along with information about the physical locations that are used to complete such steps. Service processes are explained above in the section entitled “Service Processes.”

Department data 940 comprises names of departments, which physical locations belong to each department, and the like. Hardware data 942 comprises information that allows the server 508 to communicate with hardware devices such as the tag readers 514. This information may indicate, for example, port numbers, channels, frequencies, or the like, used to communicate with each tag reader 514. The hardware data 942 can also include information that indicates where each tag reader 514 and antenna is located within the service shop 100. Such information can replace or supplement similar information stored in the location data 934. User data 944 comprises information about users, groups, and the like, including, for example, user names, group names, permission settings, and the like.

A skilled artisan will appreciate, in light of this disclosure, that certain embodiments may not store every one of the foregoing types of data, and that other embodiments may store information in addition to the foregoing. For example, in embodiments which do not allow users to group physical locations together as teams or as departments, team data 936 and department data 940 may be omitted.

Data Transfer Station

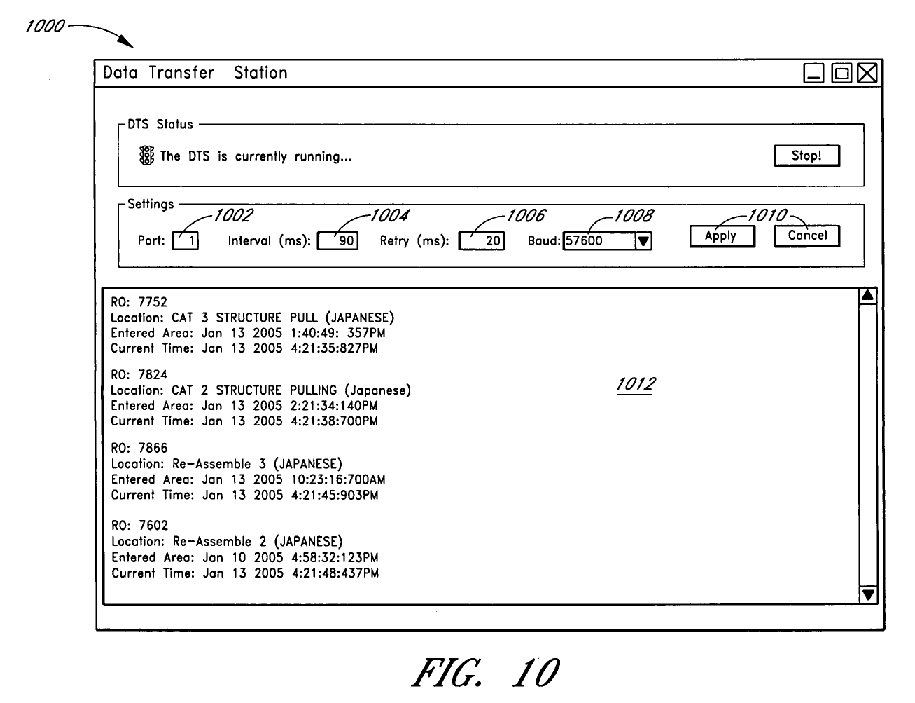

The data transfer station 532 comprises one or more modules configured to receive readings form the tag readers 514. A variety of ways to receive such readings exist. In one such way, the data transfer station 532 receives readings from the tag readers 514 by periodically polling each tag reader 514. FIG. 10 illustrates a user interface for the data transfer station 532. As illustrated, a data transfer station user interface 1000 may include entry boxes for entering settings such as a port number 1002, a polling interval 1004, a retry interval 1006, and a baud rate 1008. The port number 1002 identifies a port used by the data transfer station 532 to communicate with the tag readers 514. The polling interval 1004 determines how often the data transfer station 532 polls each tag reader 514. For cases in which the data transfer station 532 fails to communicate with a tag reader 514, the retry interval 1006 determines when the data transfer station 532 will make a second or subsequent attempt. The baud rate 1008 identifies the rate of data transfer between the data transfer station 532 and the tag readers 514. Various user controls 1010 allow a user to modify the foregoing settings, cancel changes to the settings, or stop the data transfer station 532.

The data transfer station user interface 1000 can further include a location status window 1012 that shows physical location information related to the last few readings received by the data transfer station 532. The location status window 1012 can include, for example, recently read repair order numbers or car identifiers, a description of the physical location occupied by the tags associated with such repair order numbers or car identifiers, an indication of when the car or other object entered the physical location, and the current time at the time of the read. Portions of this information are generated by the data transfer station 532 by using information provided by the tag readers 514 to look up associated information within the server data 530. In addition to being used to generate the location status window 1012, the readings received by the data transfer station 532 are used to update portions of the server data 530, such as, for example, the location data 934.

As indicated, the data transfer station 532 can be configured to use other ways to receive readings from the tag readers 514, and the data transfer station 532 is not limited to using the way described in the preceding paragraphs. For example, the following paragraphs describe different methods and modes in which the data transfer station 532 can communicate with the tag readers 514.

This application now describes two methods of connecting the data transfer station 532 to the tag readers 514. One method is to broadcast messages over a serial communications network, such as, for example, by using a converter on a serial port that converts from RS232 to either RS422 or RS485. The data transfer station 532 broadcasts messages via the serial communications network. The messages can be transmitted using any known and suitable wire-based or wireless technology, such as, for example, CAT 5 cabling. The messages include a reader address and an action to be performed by the reader at the specified address. In one embodiment, the reader address can be one of 32 numbers, with the address of “0” being reserved to the server. Accordingly, in this embodiment, 31 readers can be addressed. Alternative embodiments can provide larger addresses in order to be enable the addressing of more than 31 readers. When the reader identified in the message receives the message, the reader performs the specified action and responds to the data transfer station 532. For example, if a message asks the reader to read any tags within its reception range and report which tags it has read, the reader reads the tags and transmits a message to the data transfer station 532 that includes a list of the tags that it has read.

A second method for connecting the data transfer station 532 with the tag readers 514 is via Transmission Control Protocol/Internet Protocol (“TCP/IP”). The data transfer station 532 sends Texas Instruments Registration and Identification System (“TIRIS”) bus protocol commands to a specified Internet Protocol (“IP”) address instead of to the reader address. Each reader is treated as if it were the sole reader configured on the reader network. Because this embodiment uses IP addresses instead of the 31 addressable reader format, the system is scalable well beyond 31 readers. At each reader a converter that processes the TCP/IP traffic converts the data to RS232 and interfaces with the reader. This format is preferred due to relative ease of communicating over a TCP/IP network and increased scalability.

The application now describes four different modes in which the data transfer station 532 and the readers 514 interact in order to make tag readings and report such tag readings to the data transfer station 532. A first mode is a passive gate mode. This communication mode preferably has one reader per antenna, such that no other antennas exist unless they are configured to process the same physical location. Each reader reads any tag that passes within range of the reader's antenna and stores the data in memory. The data transfer station 532 polls each gate mode reader and requests a list of tags that have passed within range of the reader's antenna. Each polled reader retrieves the list from memory and transmits it to the data transfer station 532. This communications mode can support at least up to 31 physical locations using one serial port. If the TCP/IP communication method is used as described above then there is no theoretical limit to the number of physical locations that can be defined.

A second communications mode is the polling mode. In the polling mode the data transfer station 532 communicates with, in turn, each the reader and antenna combination assigned to each physical location. The data transfer station asks each reader and antenna combination to determine whether a tag is in range. In this mode, one tag is read at a time and the data transfer station 532 reads the tags as quickly as it can cycle through each of the physical locations. In one embodiment, the serial port communication method allows as many as four antennas to be assigned to each reader such that 124 total physical locations can be configured. The TCP/IP communication method has no theoretical limit to the number of physical locations that can be defined. All else being equal, in this mode increasing the number of physical locations being read will decrease the frequency with which each physical location is read. Accordingly, increasing the number of physical locations may result in a reduction of reliability in the system, particularly in service shops in which service objects move rapidly from one physical location to another.

A third communication mode is passive polling triangulation. This mode is similar to the polling mode. However, rather then having each physical location associated with a particular antenna, this mode stores a geographical area occupied by each physical location and a geographical area occupied by each antenna. The data transfer station 532 polls each antenna and stores a list of tags read by each antenna. The data transfer station 532 then measures the response time from each antenna that read the same tag and calculates an estimate of where the tag is geographically located in comparison to the defined geographically areas of the antennae. The data transfer station 532 compares the estimated geographical area occupied by each tag with the stored geographical areas occupied by each physical location and makes a determination about which physical location each tag occupies. As in normal polling, increasing the number of antennae to poll can increase the time it takes to receive a reading for each physical location and can reduce reliability of the system.

A fourth communication mode is active triangulation. Active triangulation uses tags that have a battery and send out periodic pulses. Antennae arrayed throughout the service shop 100 record data from these pulses and when the pulse was received. The antennae pass the data along to the data transfer station 532, which triangulates a position for each tag in the same manner as with passive polling triangulation. Preferred hardware for use with this communications mode are the Battery Assisted Passive readers and transponders from Alien Technology or the Active Wave Inc. Long Range Reader and Active Tags.

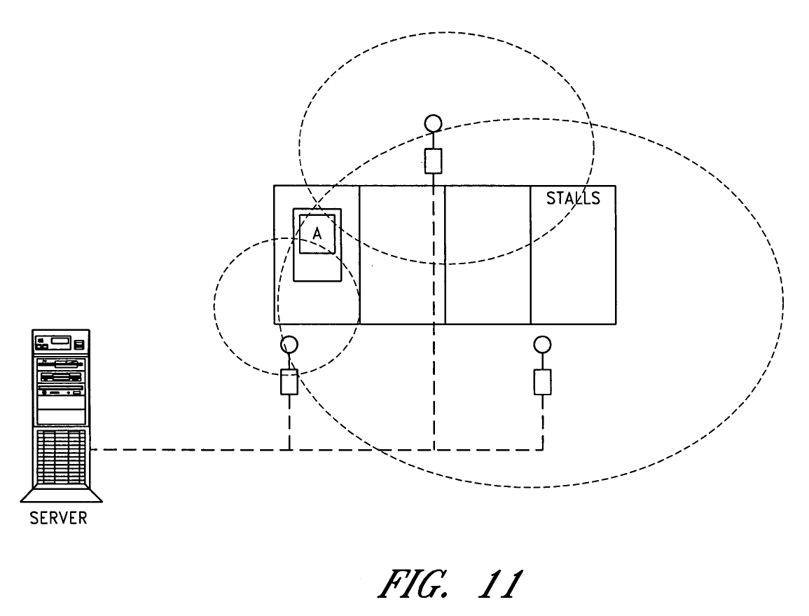

Passive polling triangulation and active triangulation can make use of a Real Time Location System (“RTLS”). RTLS uses longer range readers to triangulate the position of detected transmitters. Each reader has one antenna. The antennae are arranged in a grid approximately every 100 to 200 square feet. It is anticipated that future antennae will be able to be spaced farther apart. Triangulation is used, as explained above with respect to passive polling triangulation and active triangulation. FIG. 11 illustrates the detection and triangulation of a Tag A.

One purpose of the data transfer station 532 is to allow the application to track all automobiles in the service shop 100. Automobiles not detected in any of the physical locations are assigned the status of “Out of System.” This status means that the car was once read and known to be in a physical location, but is no longer detected at that physical location. Preferably, the “Out of System” status remains until one or more of the tag readers 514 locates the automobile. In some cases, multiple readers 514 may detect a tag 511, which may yield ambiguous location results unless a manner to resolve any inconsistent reads is provided. Accordingly, in some embodiments the data transfer station 532 employs logic, which can include artificial intelligence algorithms, to resolve inconsistent reads. For example, a comparison can be made between the reads and the artificial intelligence known to a skilled artisan as potential fields is applied. Each possible physical location of each service object is assigned variable potential depending on the likelihood that the vehicle is at that physical location. Potential increases with each additional read, the duration that the vehicle is believed to have been at the physical location, the history of the vehicle in comparison to the reads, the proximity to other physical locations reading the vehicle, which physical locations the vehicle is expected to visit based on the service process associated with the vehicle, and the response time for the reader to issue the read command and receive the response. All of these variables are given a weight value that modifies each physical location's potential. The physical location that has the highest potential is the one that will be assigned the vehicle. If another of the physical locations passes the current leader, the car will be reassigned to the new physical location. If minimal time has passed then the total time spent in the first physical location is transferred to the new physical location and the old entry is deleted. If the time difference is substantial, then a new entry is created and the old physical location entry is closed.

In one embodiment, the foregoing potential fields logic applies only if the automobile is detected at multiple physical locations repeatedly. If the vehicle moves from one physical location to another in a short period of time never returning to the first physical location then the logic will not be applied. This is because the automobile is assumed to be merely moving from one physical location to another under such circumstances. However, if the automobile appears to move, according to the tag readers 514, between a series of physical locations in a short amount of time and then return to the starting physical location, the logic is applied and the car appears as if it never left the original starting physical location. This is because it is assumed, under such circumstances, that the automobile is merely being moved temporarily for purposes not related to servicing the automobile, such as, for example, merely making way for another automobile.

The following descriptions comprise technical details for one embodiment of the data transfer station 532, tag readers 514, tags 511, and related components. While these particular technical details can be used for an advantageous implementation of the system described herein, they are not required and do not limit the invention. The data transfer station 532 can run on a server running Windows 2003 Server with a Microsoft SQL Server database. The data transfer station 532 modules can run on the .Net Framework 1.1.

A preferred communications medium is a serial port using an RS232 interface transitioned to an RS485 interface. A CAT5 to RS232 interface can also be used for TCP/IP communications rather than serial port communications. Preferred reader hardware is Texas Instruments Series 2000 Reader with RS422/485 interface. This reader is connected to a Series 2000 4-Channel Multiplexer. Four Series 2000 tuning modules and antennae are connected to the multiplexer. The reader and multiplexer are contained in a plastic housing with a power supply connected to the outside. The tag read by this reader is a plastic marker hat that has a 85 mm Read/Write transponder disk attached to the top. The bottom of the plastic hat is magnetic and can rest on any metallic object such as an automobile.

The data transfer station 532 can use the TIRIS Bus Protocol, as described by Texas Instruments and known to a skilled artisan, to communicate with each reader. The readers function as described by Texas Instruments for reading the tags, and as will be appreciated by a skilled artisan.

Video Workstations

Each video workstation 510 comprises one or more modules chosen from a map module 536, a report/forecast module 538, a car information module 540, a delay notifier module 542, an administration module 544, and a priority list module 546. In one embodiment, these modules are equivalent to the map module 516, the report/forecast module 518, the car information module 520, the delay notifier module 522, the administration module 524, and the priority list module 526 of the client workstation 522. Indeed, in one embodiment, the video workstation 510 is essentially a client workstation whose graphical output is redirected to a number of displays 548. Preferably, such displays 548 are large flat panel displays mounted on walls throughout the service shop 100 in order to prominently display information to service people. Preferably, the video workstation 510 is set to display the shop map 200 in order to prominently display a visual location status display throughout the service shop 100. Alternatively, the video workstation 510 can be set up to display anything that the client workstation 504 can display. In another alternative, the video workstation 510 can be a limited purpose workstation configured only to display the shop map 200, and having only a map module 536.

In one embodiment, the video workstations 510 generate a standard VGA video signal, which is sent through a modulator that then relays the modulated signal along a CAT5 cable to the multiple displays 548. At each flat panel display 548 or other display device, the signal is converted back to VGA and received by the flat panel display 548 via a VGA port. One preferred flat panel display is a Daewoo 42″ Plasma Television.

Customer Web Browser

The customer web browser 512 is any standard web browser that a customer uses to connect to the web server 528 in order to receive status information regarding repairs being done to the customer's automobile or other service object. Certain embodiments in which customer web access is not provided may not allow a customer web browser 512 to connect to the web server 528, or may not have a web server 528 at all.

Tag Readers/Tags

The tag readers 514 comprise one or more antennae 550 for receiving transmissions from the transmitter tags 511. In one embodiment, the tag readers 514 passively receive transmissions from the transmitter tags 511. In this embodiment, the transmitter tags 511 continually or periodically transmit information stored in the tags 511 and the antennae 550 receive the transmissions when the tags 511 are within the reception range of an antenna 550. In another embodiment, the tag readers 514 are at least partially active in receiving transmissions from the tags 511. For example, the tag readers 514 may be configured to periodically transmit information that invites response from any tag 511 within its transmission range. In this embodiment, each tag 511 is configured to receive such transmissions, and in response, transmit the information stored in the tag 511. The tag reader 514 then receives the transmitted information from the tag 511.

Preferably, the transmissions from the tags 511 to the tag readers 514 do not require the tag readers 514 to optically detect the transmissions in order to read them. Such optical detection is required, for example, with bar code scanners or other scanners that rely on pattern recognition. Preferably, however, the transmissions from the tags 511 to the tag readers 514 comprise wireless electromagnetic signals of sufficient intensity to reach the tag readers 514 even though they sometimes must travel through or around air or objects located between the tag 511 and the tag reader 514. Advantageously, such signals can be read by the tag readers 514 even without being physically connected to the tags 511 or being in the line-of-sight of the tags 511. In one preferred embodiment, the tags 511 are radio frequency identification (“RFID”) tags and the tag readers 514 are RFID readers.

A skilled artisan will appreciate that many types of tags 511 and tag readers 514 exist and that many such tags 511 and tag readers 514 could be used to make and use the systems and methods described herein.

Methods of Tracking Objects Being Serviced

A skilled artisan will appreciate, in light of this disclosure, that the embodiments described above enable various methods of tracking objects being serviced. This section describes two of these methods. Many additional methods not explicitly described herein, however, will be apparent to a skilled artisan from the above system description.

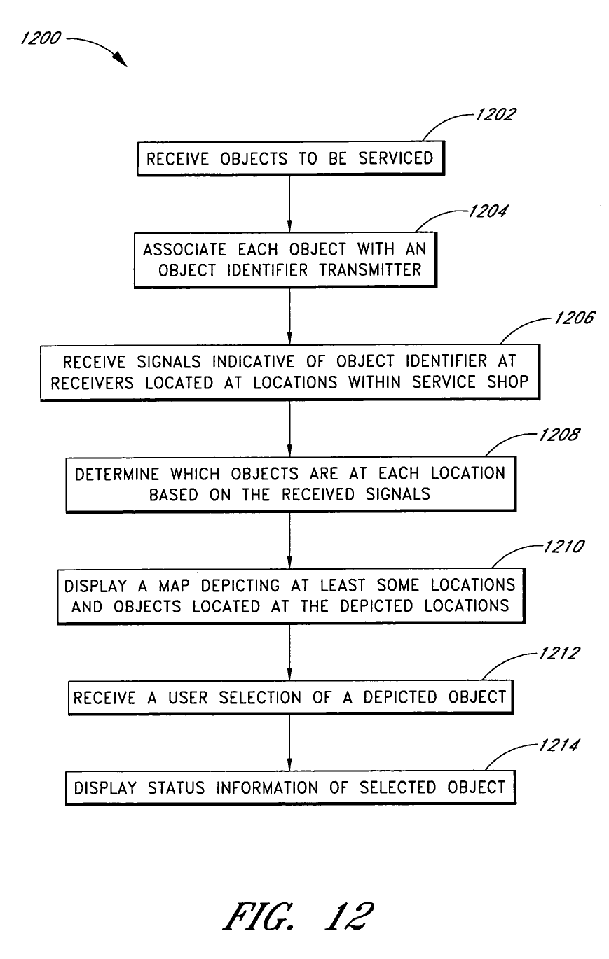

FIG. 12 is a flowchart illustrating a process of tracking objects being serviced. A process 1200 of tracking objects being serviced begins in a block 1202, in which the process 1200 receives objects to be serviced. For example, this occurs when an automobile in need of service enters a service shop. In a block 1204, the process 1200 associates each object with an object identifier transmitter. The object identifier transmitter may comprise an RFID tag. The object may be associated with the object identifier transmitter by physically connecting the tag to the object such that the tag goes wherever the object goes. Associating the object with an object identifier transmitter may further comprise entering a record into a computer in which object information is stored in association with an object identifier that is equivalent to an object identifier stored in the transmitter.

In a block 1206, the process 1200 receives signals indicative of object identifiers at receivers located at physical locations within a service shop. The signals may be radio frequency transmissions. The receivers may be antennae of tag readers as described herein. The receivers may be antennae of RFID tag readers. In a block 1208, the process 1200 determines which objects are at each physical location based on the received signals. This may include extracting an object identifier from each received signal and making a determination that the objects identified by the object identifiers are in a physical location that is close to the receivers that received each signal. Alternatively or additionally, this may include receiving a signal at multiple receivers and triangulating in order to determine the origin of the signal.

In a block 1210, the process 1200 displays a map depicting at least some physical locations and objects located at the depicted physical locations. Depicting the objects may comprise displaying an object status summary. In a block 1212, the process 1200 receives a user selection of at least one of the objects depicted on the map. Receiving the user selection may comprise receiving a selection input by the user by selecting a hypertext link. In a block 1214, the process 1200 displays status information of the selected object. Displaying status information of the selected object may comprise displaying detailed information regarding the status of a service process that the object is passing through. The detailed status information may include a service path history of physical locations already visited by the object, a service path forecast of physical locations expected to be visited by the object, or both.

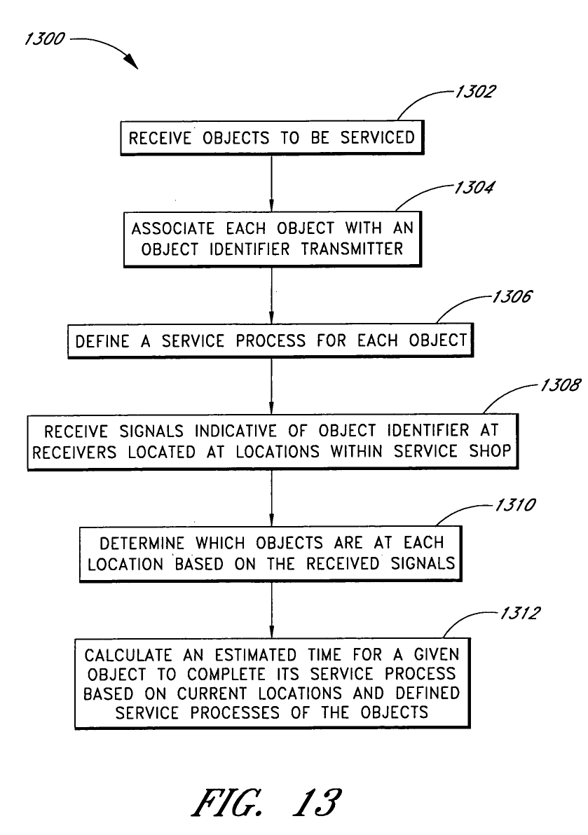

FIG. 13 is a flowchart illustrating another process of tracking objects being serviced. A process 1300 of tracking objects being serviced begins in a block 1302, in which the process 1300 receives objects to be serviced. For example, this occurs when an automobile in need of service enters a service shop. In a block 1304, the process 1300 associates each object with an object identifier transmitter. The object identifier transmitter may comprise an RFID tag. The object may be associated with the object identifier transmitter by physically connecting the tag to the object such that the tag goes wherever the object goes. Associating the object with an object identifier transmitter may further comprise entering a record into a computer in which object information is stored in association with an object identifier that is equivalent to an object identifier stored in the transmitter.

In a block 1306, the process 1300 defines a service process for each object. A service process comprises an ordered list of steps to be performed in order to service the object. A service process may further be associated with physical locations to be visited by an object during the service process. In a block 1308, the process 1300 receives signals indicative of object identifiers at receivers located at physical locations within a service shop. The signals may be radio frequency transmissions. The receivers may be antennae of tag readers as described herein. The receivers may be antennae of RFID tag readers. In a block 1310, the process 1300 determines which objects are at each physical location based on the received signals. This may include extracting an object identifier from each received signal and making a determination that the objects identified by the object identifiers are in a physical location that is close to the receivers that received each signal. Alternatively or additionally, this may include receiving a signal at multiple receivers and triangulating in order to determine the origin of the signal.

In a block 1312, the process 1300 calculates an estimated time for a given object to complete its service process based on current physical locations and defined service processes of the objects. This may comprise projecting when each physical location required by the given object will be available to the object. Such projection of when each physical location will be available may be based at least in part on how many other objects are in line to visit the physical location prior to the given object. Such projection may further be based on an expected time that each object will occupy each physical location. The expected time may comprise an average time that objects serviced in the past during a specified time period occupied each physical location.

Each of the foregoing methods can be performed on any object that is being serviced, including any of the service objects listed in this application or any other service object known to a skilled artisan in light of this disclosure.

Flexibility of Implementation

While this application describes, for illustrative purposes only, certain preferred embodiments, a skilled artisan will appreciate, in light of this disclosure, that there exists a great amount of flexibility in how to implement specific embodiments of the invention. Accordingly, the invention is not limited to the particular embodiments described herein, but also encompasses any variations and alternative embodiments that would be appreciated by a skilled artisan in light of this disclosure. For example, a skilled artisan will appreciate, in light of this disclosure, how to modify many of the embodiments described herein by omitting one or more components, computers, modules, functions, or the like, while maintaining a fully operative alternative embodiment that has some or all of the advantages described or apparent herein. Similarly, a skilled artisan will appreciate, in light of this disclosure, how to combine one or more components, computers, modules, functions, or the like from one embodiment with the components, computers, modules, and functions of another embodiment. All such subcomponent or combination embodiments that would be appreciated by a skilled artisan in light of this disclosure are within the scope of this disclosure.

A skilled artisan will appreciate, in light of this disclosure, that network architectures are flexible and that the network architecture described herein can be modified while still performing the functions described herein. For example, this application describes certain functions as being performed by a given workstation, such as a client workstation. Similarly, the application describes other functions as being performed by a video workstation. No strict division of labor is intended or required by this application. A single computer could be configured to perform the functions of multiple computers described herein. For example, one computer could be configured to perform the functions of both a client workstation and a server. Alternatively, multiple computers could be configured such that they collectively perform the functions that are described herein as being performed by a single computer. For example, one server could be configured as a web server and a separate server could be configured as a data transfer station.

Similarly, a skilled artisan will appreciate, in light of this disclosure, that many implementations for each of the modules described herein exist. None of the modules described herein is limited to any particular implementation but encompasses any implementation for the module that performs the functions of the module. While this application has described a number of distinct modules, such as, for example, a map module and a report/forecast module, no rigid separation of modules is intended or required. A skilled artisan will appreciate, in light of this disclosure, that two or more modules can be combined into a single module or that one module can be separated into two or more modules. Additionally, the term “module” encompasses modules that are implemented in software, in hardware, in firmware, or in any combination of software, hardware, or firmware. For example, a software module comprises any grouping of one or more computer executable instructions that define one or more calculations and that when executed cause a processor to perform the defined calculations. The computer executable instructions can be encoded onto a computer readable medium that can be read and executed by one or more computers. A firmware module comprises any grouping of one or more instructions stored in firmware that define one or more calculations and that when executed cause a processor to perform the defined calculations. A hardware module comprises any grouping of one or more gates or other logic circuits that perform one or more calculations.

The claims which follow, whether originally presented or added during prosecution, particularly set forth and claim the invention. The claims intentionally omit certain components, functions, and features which have been described as advantageous or preferred in this written description, the abstract, and the summary. This omission indicates that while such components, functions, and features are advantageous or preferred, they do not limit the claimed invention.

1. A service shop comprising:
a plurality of physical locations, at least some of the physical locations being configured as a place for the performance of at least one service on a service object; and
a computer network configured to track movement of tagged service objects from physical location to physical location, the computer network comprising:
one or more tag readers comprising one or more antennae configured to receive transmissions from tags each encoded with an identifier and connected to an associated tagged service object and to transmit identifiers obtained from the tag transmissions;
one or more servers configured to receive identifiers transmitted from the tag readers, to determine, based at least on the identifiers and information, derived from the transmissions, about which tag reader antennae received the transmissions, which physical location each service object associated with the received identifiers occupies, and to maintain information sufficient to generate a report showing at least any past physical locations visited by each service object and a current physical location occupied by each service object; and
one or more client workstations configured to receive information from the one or more servers and to generate from the received information at least a visual map depicting a graphical representation displaying at least some of the physical locations of the service shop together with summary status information showing which service objects occupy the displayed physical locations.

2. The service shop of claim 1, wherein the tag readers are configured to receive transmissions from the tags without performing an optical scan of the tags or making physical contact with the tags.

3. The service shop of claim 2, further comprising a tagging area configured as a place for the connection of a tag to a service object in order to create a tagged service object, the tagging area having one or more tag writer workstations for encoding an identifier onto each tag.

4. The service shop of claim 2, wherein the service shop comprises an automobile service shop and the service objects comprise automobiles.

5. The service shop of claim 2, wherein the computer network is further configured to associate with each service object one of a plurality of service processes, each service process defining an ordered list of one or more service steps to be performed to a service object and one or more physical locations to be visited for the performance of the service steps, the servers are further configured to maintain information sufficient to forecast future physical locations expected to be visited by each service object based at least in part on the service object's associated service process, and the client workstations are further configured to display at least one report that forecasts future physical locations expected to be visited by a selected service object.

6. The service shop of claim 5, wherein the servers are further configured to forecast, in addition to future physical locations to be visited, an estimated time of completion of the service process associated with each service object, the estimated time of completion derived at least partially from projected availability of physical locations defined as part of each service object's service process.

7. The service shop of claim 2, wherein the tag readers are configured to receive transmissions using radio frequency transmissions from the tags which comprise radio frequency identification tags.

8. A computer readable storage medium comprising a substrate configured to encode computer executable instructions, the computer executable instructions being configured, when executed on one or more computers, to perform the following:
track movement of tagged service objects from physical location to physical location, each physical location being one of a plurality of physical locations and configured as a place for the performance of at least one service on a service object;
receive identifiers and source information from one or more radio frequency identification receivers configured to receive transmissions from tags each encoded with an identifier and connected to an associated tagged service object, the source information configured to identify which receiver received each identifier;
determine, based at least on the identifiers and which receivers received the transmissions, which physical location each service object associated with the received identifiers occupies, and to maintain information sufficient to generate a report showing at least any past physical locations visited by each service object and a current physical location occupied by each service object; and
generate from the maintained information at least a visual map depicting a graphical representation displaying at least some of the physical locations together with summary status information showing which service objects occupy the displayed physical locations.

9. The computer readable storage medium of claim 8, wherein the computer executable instructions are further configured, when executed by a computer, to generate at least one of a first report, a second report, or a third report, wherein:
the first report displays at least, for one or more of the physical locations, statistics regarding how many service objects have entered each physical location during a specified time period, an aggregate time that the service objects have been in each physical location, and an average time spent per service object per physical location;
the second report displays at least, for each of a plurality of service objects, an identifier associated with the service object, an arrival date for the service object at a service shop, and a departure date for the service object at the service shop; and
the third report displays at least a plurality of delays that occurred at a service shop during a specified date range, each physical location at which each delay occurred, an identifier associated with each service object for which each delay occurred, and a date and time of each delay.

10. The computer readable storage medium of claim 8, wherein the computer executable instructions are further configured, when executed by a computer, to identify circumstances in which the received identifiers and source information lead to ambiguity in a determination regarding which physical location a particular service object occupies, and to resolve such ambiguity by performing a potential fields calculation to determine which physical location the particular service object most likely occupies.

11. The computer readable storage medium of claim 8, wherein the computer executable instructions are further configured, when executed by a computer, to associate with each service object one of a plurality of service processes, each service process defining an ordered list of one or more service steps to be performed to a service object and one or more physical locations to be visited for the performance of the service steps, to maintain information sufficient to forecast future physical locations expected to be visited by each service object based at least in part on the service object's associated service process, and to display at least one report that forecasts future physical locations expected to be visited by a selected service object.

12. The computer readable storage medium of claim 11, wherein the computer executable instructions are further configured, when executed by a computer, to forecast, in addition to future physical locations to be visited, an estimated time of completion of the service process associated with each service object, the estimated time of completion derived at least partially from projected availability of physical locations defined as part of each service object's service process.

13. The computer readable storage medium of claim 12, wherein the projected availability of a particular physical location for a particular service object is derived at least in part from a determination of how many other service objects are projected to visit the particular physical location prior to a projected visit of the particular service object to the particular physical location and an estimated time for each visit by the other service objects to the particular physical location.

14. A method of tracking service objects through a service process, the method comprising:
receiving a plurality of service objects to be serviced;
associating each service object with an identifier tag;
receiving signals indicative of identifiers at receivers located within a service shop;
determining which service objects are at each location based at least on the received signals; and
displaying a map depicting at least some physical locations and service objects located at the depicted physical locations.

15. The method of claim 14, further comprising receiving a user selection of at least one of the depicted service objects and displaying status information about the selected service object.

16. The method of claim 15, wherein associating each service object with an identifier tag comprises associating each service object with an identifier tag that comprises a radio frequency identification tag.

17. The method of claim 15, wherein determining which service objects are at each location comprises extracting an object identifier from each received signal and making a determination that the objects identified by the object identifiers are in a physical location that is close to the receivers that received each signal.

18. The method of claim 15, wherein determining which service objects are at each location comprises receiving a signal at multiple receivers and triangulating in order to determine an origin of the signal.

19. A method of tracking service objects through a service process, the method comprising:
receiving a plurality of service objects;
associating each service object with an identifier tag comprising a radio frequency identification tag;
associating a service process with each service object;
receiving from at least some of the identifier tags signals indicative of identifiers at receivers located at physical locations within a service shop;
determining which objects are at each physical location based at least in part on the received signals; and
calculating an estimated time for a given service object to complete its service process based at least in part on current physical locations and associated service processes of the service objects.

20. The method of claim 19, wherein calculating an estimated time for a given service object comprises projecting when each physical location required by the given service object will be available to the given service object.

21. The method of claim 20, wherein the projection of when each physical location will be available is based at least in part on how many other service objects are in line to visit the physical location prior to the given object.

22. The method of claim 21, wherein the projection of when each physical location will be available is further based at least in part on an expected time that each object will occupy each physical location.

23. A computer system comprising one or more computers configured to perform the method of claim 14.

24. A computer system comprising one or more computers configured to perform the method of claim 19.
